(19) United States
(12) Patent Application Publication
(10) Pub. No.: US 2018/0373812 A1
(43) Pub. Date: Dec. 27, 2018

(54) METHODS, SYSTEMS, AND COMPUTER PROGRAM PRODUCTS FOR TAGGING A RESOURCE

(71) Applicant: SITTING MAN, LLC, Raleigh, NC (US)

(72) Inventor: Robert Paul Morris, Raleigh, NC (US)

(21) Appl. No.: 16/116,888

(22) Filed: Aug. 29, 2018

Related U.S. Application Data
(63) Continuation of application No. 14/274,639, filed on May 9, 2014.
Application No. 14/274,639 is a continuation-in-part of application No. 13/622,366, filed on Sep. 19, 2012, now abandoned.
Application No. 13/622,366 is a continuation-in-part of application No. 13/622,367, filed on Sep. 19, 2012, now abandoned.
Application No. 13/622,367 is a continuation-in-part of application No. 13/622,372, filed on Sep. 19, 2012, now abandoned.
Application No. 13/622,372 is a continuation-in-part of application No. 13/622,370, filed on Sep. 19, 2012, now abandoned.
Application No. 13/622,370 is a continuation-in-part of application No. 13/622,371, filed on Sep. 19, 2012, now abandoned.
Application No. 13/622,371 is a continuation-in-part of application No. 13/622,368, filed on Sep. 19, 2012, now abandoned.

(51) Int. Cl. G06F 17/30

(52) U.S. Cl. CPC G06F 17/30997

(57) ABSTRACT

Methods and systems are described for tagging a resource. In an aspect, a matched tag is created by associating a user identified tag with a tagging criterion that is based on data other than the tag. A determination is made that the tagging criterion is met for each resource in a plurality of resources. Each resource in the plurality is tagged with the tag, in response to the determining. Presentation information is sent to present, via an output device, a tag user interface element representing the tag, that represents the tag, as a target for a user input to initiate an operation that identifies a resource in the plurality.

### RELATED APPLICATIONS

The present application is a continuation of and claims priority to U.S. patent application Ser. No. 14/274,639, filed May 9, 2014 and entitled “Methods, Systems, and Computer Program Products for Tagging a Resource,” which is a continuation-in-part of and claims priority to the following U.S. Patent Applications: U.S. patent application Ser. No. 13/622,366 filed Sep. 19, 2012 and entitled “Methods, Systems, and Program Products for Tagging a Resource,” U.S. patent spplication Ser. No. 13/622,367 filed Sep. 19, 2012 and entitled “ Methods, Systems, and Program Products for Distinguishing Tags for a Resource,” U.S. patent application Ser. No. 13/622,372 filed Sep. 19, 2012 and entitled “Methods, Systems, and Program Products for Navigating Tagging Contexts,” U.S. patent application Ser. No. 13/622,370 filed Sep. 19, 2012 and entitled “Methods, Systems, and Program Products for Automatically Managing Tagging of a Resource,” U.S. patent application Ser. No. 13/622,371 filed Sep. 19, 2012 and entitled “Methods, Systems, and Program Products for Locating Tagged Resources in a Resource Scope,” and U.S. patent application Ser. No. 13/622,368 filed Sep. 19, 2012 and entitled “Methods, Systems, and Program Products for Identifying a Matched Tag Set,” the entire contents of each are herein incorporated by reference.

This application is related to the following commonly owned U.S. Patent Applications: application Ser. No. 13/622,367 (Docket No DRV0005) filed on Sep. 19, 2012, entitled “Methods, Systems, and Program Products for Distinguishing Tags for a Resource”;

Application Ser. No. 13/622,372 (Docket No DRV0007) filed on Sep. 19, 2012, entitled “Methods, Systems, and Program Products for Navigating Tagging Contexts”;

Application Ser. No. 13/622,370 (Docket No DRV0008) filed on Sep. 19, 2012, entitled “Methods, Systems, and Program Products for Automatically Managing Tagging of a Resource”;

Application Ser. No. 13/622,371 (Docket No DRV0009) filed on Sep. 19, 2012, entitled “Methods, Systems, and Program Products for Locating Tagged Resources in a Resource Scope”, and

Application Ser. No. 13/622,368 (Docket No DRV0021) filed on Sep. 19, 2012, entitled “Methods, Systems, and Program Products for Identifying a Matched Tag Set”.

### BACKGROUND

Tagging has become a common way to allow users to categorize and/or otherwise create relationships between resources on the Web. Resources, such as images, video, audio, documents, and other web content are tagged every day. One of the disadvantages of tagging is that it is user intensive. Each tag associated with the many resources on the Web is added by a user. Another disadvantage is that tagging is static in that tags for a resource do not change even if the resource changes, unless a user changes the tags. Not only is this inefficient, it is a source or errors and/or inconsistencies in tags. For example, this user intensive effort increases the number tags that use alternate spellings, which are typically treated as different tags. Misspellings lead to further errors. Additionally, when a resource is added or created it has not tags. It may take quite some time before the set of tags associated with a new resource becomes stable. Still further, this user intensive effort leads to the loss of many tags, as users choose not to make the effort to tag resources.

Accordingly, there exists a need for methods, systems, and computer program products for tagging a resource.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for tagging a resource. In one aspect, the method includes creating a matched tag by associating a user identified tag with a tagging criterion that is based on data other than the tag. The method further includes determining that the tagging criterion is met for each resource in a plurality of resources. The method still further includes tagging each resource in the plurality with the tag, in response to the determining. The method additionally includes sending presentation information to present, via an output device, a tag user interface element, that represents the tag, as a target for a user input to initiate an operation that identifies a resource in the plurality. Performing at least one the preceding actions comprising the method includes execution of an instruction by a processor.

Also, a system for tagging a resource is described that includes one or more processors and logic encoded in one or more tangible media for execution by the one or more processors that when executed is operable for creating a matched tag by associating a user identified tag with a tagging criterion that is based on data other than the tag; determining that the tagging criterion is met for each resource in a plurality of resources; tagging each resource in the plurality with the tag, in response to the determining; and sending presentation information to present, via an output device, a tag user interface element, that represents the tag, as a target for a user input to initiate an operation that identifies a resource in the plurality.

Further, a system for tagging a resource is described. The system includes a tag director component for creating a matched tag by associating a user identified tag with a tagging criterion that is based on data other than the tag. The system further includes a criterion match component for determining that the tagging criterion is met for each resource in a plurality of resources. The system still further includes a tagging component for tagging each resource in the plurality with the tag, in response to the determining. The system yet further includes a tag handler component for sending presentation information to present, via an output device, a tag user interface element, that represents the tag, as a target for a user input to initiate an operation that identifies a resource in the plurality. The system also includes a processor, wherein at least one of the tag director component, the criterion match component, the tagging component, and the tag handler component includes an instruction that is executed by the processor during operation of the system.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary execution environment, including and/or otherwise provided by a hardware device, in which the subject matter may be implemented;

FIG. 2 is a flow diagram illustrating a method for tagging a resource according to an aspect of the subject matter described herein;

FIG. 3 is a block diagram illustrating an arrangement of components for tagging a resource according to another aspect of the subject matter described herein;

FIG. 4A is a block diagram illustrating an arrangement of components for tagging a resource according to another aspect of the subject matter described herein;

FIG. 4B is a block diagram illustrating an arrangement of components for tagging a resource according to another aspect of the subject matter described herein;

FIG. 4C is a block diagram illustrating an arrangement of components for tagging a resource according to another aspect of the subject matter described herein;

FIG. 4D is a block diagram illustrating an arrangement of components for tagging a resource according to another aspect of the subject matter described herein;

FIG. 5 is a network diagram illustrating a system for tagging a resource according to another aspect of the subject matter described herein;

FIG. 6A is a diagram illustrating a user interface presented via a display according to another aspect of the subject matter described herein;

FIG. 6B is a diagram illustrating a user interface presented via a display according to another aspect of the subject matter described herein; and

FIG. 6C is a diagram illustrating a user interface presented via a display according to another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure.

Unless otherwise defined, all technical and scientific terms used herein have the same meaning as commonly understood by one of ordinary skill in the art to which this disclosure belongs. Although methods, components, and devices similar or equivalent to those described herein can be used in the practice or testing of the subject matter described herein, suitable methods, components, and devices are described below.

All publications, patent applications, patents, and other references mentioned herein are incorporated by reference in their entirety. In case of conflict, the present specification, including definitions, will control. In addition, the materials, methods, and examples are illustrative only and not intended to be limiting.

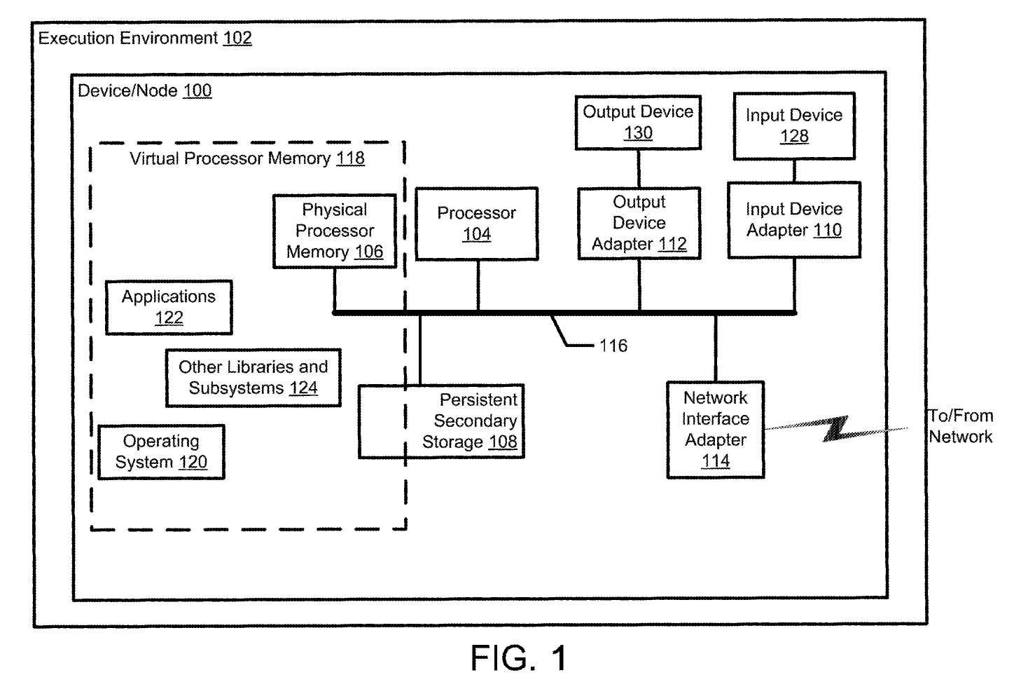

An exemplary device included in an execution environment that may be configured according to the subject matter is illustrated in FIG. 1. An “execution environment”, as used herein, is an arrangement of hardware and, in some aspects, software that may be further configured to include and/or otherwise host an arrangement of components for performing a method of the subject matter described herein. An execution environment includes and/or is otherwise provided by one or more devices. The execution environment is said to be the execution environment of the device and/or devices. An execution environment may be and/or may include a virtual execution environment including software components operating in a host execution environment. Exemplary devices included in and/or otherwise providing suitable execution environments for configuring according to the subject matter include personal computers, notebook computers, tablet computers, servers, portable electronic devices, handheld electronic devices, mobile devices, multiprocessor devices, distributed systems, consumer electronic devices, routers, communication servers, and/or any other suitable devices. Those skilled in the art will understand that the components illustrated in FIG. 1 are exemplary and may vary by particular execution environment.

FIG. 1 illustrates a hardware device 100 included in an execution environment 102. FIG. 1 illustrates that execution environment 102 includes a processor 104, such as one or more microprocessors; a physical processor memory 106 including storage locations identified by addresses in a physical memory address space of processor 104; a persistent secondary storage 108, such as one or more hard drives and/or flash storage media; an input device adapter 110, such as a key or keypad hardware, a keyboard adapter, and/or a mouse adapter; an output device adapter 112, such as a display and/or an audio adapter for presenting information to a user; a network interface component, illustrated by a network interface adapter 114, for communicating via a network such as a LAN and/or WAN; and a communication mechanism that operatively couples elements 104-114, illustrated as a bus 116. Elements 104-114 may be operatively coupled by various means. Bus 116 may comprise any type of bus architecture, including a memory bus, a peripheral bus, a local bus, and/or a switching fabric.

As used herein a “processor” is an instruction execution machine, apparatus, or device. A processor may include one or more electrical, optical, and/or mechanical components that operate in interpreting and executing program instructions. Exemplary processors include one or more microprocessors, digital signal processors (DSPs), graphics processing units, application-specific integrated circuits (ASICs), optical or photonic processors, and/or field programmable gate arrays (FPGAs). Processor 104 may access machine code instructions and data via one or more memory address spaces in addition to the physical memory address space. A memory address space includes addresses identifying locations in a processor memory. The addresses in a memory address space are included in defining a processor memory. Processor 104 may have more than one processor memory. Thus, processor 104 may have more than one memory address space. Processor 104 may access a location in a processor memory by processing an address identifying the location. The processed address may be identified by an operand of a machine code instruction and/or may be identified by a register or other portion of processor 104.

FIG. 1 illustrates a virtual processor memory 118 spanning at least part of physical processor memory 106 and may span at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is referred to as a virtual processor memory or virtual memory. The term “processor memory” may refer to physical processor memory, such as processor memory 106, and/or may refer to virtual processor memory, such as virtual processor memory 118, depending on the context in which the term is used.

Physical processor memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), RAMBUS DRAM (RDRAM), and/or XDR™ DRAM. Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable data storage medium. The drives and their associated tangible computer readable storage media provide volatile and/or nonvolatile storage for computer-readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including an operating system 120, one or more applications 122, and other program code and/or data components illustrated by other libraries and subsystems 124. In an aspect, some or all software components may be stored in locations accessible to processor 104 in a shared memory address space shared by the software components. The software components accessed via the shared memory address space are stored in a shared processor memory defined by the shared memory address space. In another aspect, a first software component may be stored in one or more locations accessed by processor 104 in a first address space and a second software component may be stored in one or more locations accessed by processor 104 in a second address space. The first software component is stored in a first processor memory defined by the first address space and the second software component is stored in a second processor memory defined by the second address space.

Software components typically include instructions executed by processor 104 in a computing context referred to as a “process”. A process may include one or more “threads”. A “thread” includes a sequence of instructions executed by processor 104 in a computing sub-context of a process. The terms “thread” and “process” may be used interchangeably herein when a process includes only one thread.

Execution environment 102 may receive user-provided information via one or more input devices illustrated by an input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by processor 104, physical processor memory 106, and/or other components included in execution environment 102.

An output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred herein to as “sensory input” with respect to the user.

A device included in and/or otherwise providing an execution environment may operate in a networked environment communicating with one or more devices via one or more network interface components. The terms “communication interface component” and “network interface component” are used interchangeably herein. FIG. 1 illustrates network interface adapter (NIA) 114 as a network interface component included in execution environment 102 to operatively couple device 100 to a network. A network interface component includes a network interface hardware (NIH) component and optionally a network interface software (NIS) component.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component for operatively coupling the device to a network. Further, the terms “device” and “node” used herein may refer to one or more devices and nodes, respectively, providing and/or otherwise included in an execution environment unless clearly indicated otherwise.

The user-detectable outputs of a user interface are generically referred to herein as “user interface elements” or abbreviated as “UI elements”. More specifically, visual outputs of a user interface are referred to herein as “visual interface elements”. A visual interface element may be a visual output of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual output”, and “visual interface element” are used interchangeably in this document. Other types of UI elements include audio outputs referred to as “audio interface elements”, tactile outputs referred to as “tactile interface elements”, and the like.

A visual output may be presented in a two-dimensional presentation where a location may be defined in a two-dimensional space having a vertical dimension and a horizontal dimension. A location in a horizontal dimension may be referenced according to an X-axis and a location in a vertical dimension may be referenced according to a Y-axis. In another aspect, a visual output may be presented in a three-dimensional presentation where a location may be defined in a three-dimensional space having a depth dimension in addition to a vertical dimension and a horizontal dimension. A location in a depth dimension may be identified according to a Z-axis. A visual output in a two-dimensional presentation may be presented as if a depth dimension existed allowing the visual output to overlie and/or underlie some or all of another visual output.

A “user interface (UI) element handler” component, as the term is used herein, includes a component of configured to send information representing a program entity for presenting a user-detectable representation of the program entity by an output device, such as a display. A “program entity” is an object included in and/or otherwise processed by an application or executable. The user-detectable representation is presented based on the sent information. Information that represents a program entity for presenting a user detectable representation of the program entity by an output device is referred to herein as “presentation information”. Presentation information may include and/or may otherwise identify data in one or more formats. Exemplary formats include image formats such as raw pixel data, JPEG, video formats such as MP4, markup language data such as hypertext markup language (HTML) and other XML-based markup, a bit map, and/or instructions such as those defined by various script languages, byte code, and/or machine code. For example, a web page received by a user agent from a remote application provider may include HTML, ECMAScript, and/or byte code for presenting one or more UI elements included in a user interface of the remote application. Components configured to send information representing one or more program entities for presenting particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space as sensory information for a user. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

As used herein, the terms “program” and “executable” refer to any data representation that may be translated into a set of machine code instructions and may optionally include associated program data. The terms are used interchangeably herein. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear the state of the object code when it is relevant. This definition can include machine code and virtual machine code, such as Java™ byte code. As used herein, the terms “application”, and “service” may be realized in one or more executables and/or in one or more hardware components. The terms are used interchangeably herein.

As used herein, the term “network protocol” refers to a formal set of rules, conventions and data structures that governs how computers and other network devices exchange information over a network. The rules, conventions, and data structures are said to be specified or defined in a specification and/or schema.

The term “network path” as used herein refers to a sequence of nodes in a network that are communicatively coupled for transmitting data in one or more data units of a specified network protocol between a pair of nodes in the network.

A “data unit”, as the term is used herein, is a data entity specified according to a network protocol for transmitting data contained in and/or otherwise identified by the data entity. A data unit is transmitted between a pair of nodes in a network path to send the data in and/or otherwise identified by the data unit from a source node to a destination node that includes a protocol endpoint of the network protocol. A network protocol explicitly and/or implicitly specifies and/or otherwise identifies a schema that defines one or more of a format for a valid data unit and a vocabulary for content of a valid data unit. One example of a data unit is an Internet Protocol (IP) packet. The Internet Protocol defines a format for an IP packet that defines a header for identifying a destination address that identifies a destination node and a payload portion for including a representation of data to be delivered to the identified destination node. The terms “data unit”, “data packet”, and “packet” are used interchangeably herein. One or more data units of a first network protocol may transmit a message of second network protocol. For example, one or more data units of the IP protocol may include a TCP message. In another example, one or more TCP data units may transmit an HTTP message.

How data is packaged in one more data units for a network protocol may vary as the data traverses a network path from a source node to a destination node. Data may be transmitted in a single data unit between two consecutive nodes in a network path. Additionally, data may be exchanged between a pair of consecutive nodes in several data units each including a portion of the data. Data received in a single data unit by a node in a network path may be split into portions included in several respective data units for transmitting to a next node in the network path. Portions of data received in several data units may be combined into a single data unit for transmitting by a node in a network path. For purposes of describing the subject matter, a data unit in which data is received by a node is referred to as a different data unit than a data unit in which the data is forwarded by the node.

A “protocol address”, as the term is used herein, for a network protocol is an identifier of a protocol endpoint that may be represented in a data unit of the protocol. For example 192.168.1.1 is an IP protocol address represented in a human readable format that may be included in an address portion of an IP header to identify a source and/or a destination IP protocol endpoint. A protocol address differs from a symbolic identifier, defined below, in that a symbolic identifier, with respect to a network protocol, maps to a protocol address. Thus, “www.mynode.com” may be a symbolic identifier for a node in a network when mapped to the protocol address 192.168.1.1. An identifier may be both a symbolic identifier and a protocol address depending on its role with respect to its use for a particular network protocol.

Since a protocol endpoint is included in a node and is accessible via a network via a network interface, a protocol address identifies a node and identifies a network interface of the node. A network interface may include one or more NICs operatively coupled to a network.

An “interaction”, as the term is used herein, refers to any activity including a user and an object where the object is a source of sensory data detected by the user. In an interaction the user directs attention to the object. An interaction may also include the object as a target of input from the user. The input from the user may be provided intentionally or unintentionally by the user. For example, a rock being held in the hand of a user is a target of input, both tactile and energy input, from the user. A portable electronic device is a type of object. In another example, a user looking at a portable electronic device is receiving sensory data from the portable electronic device whether the device is presenting an output via an output device or not. The user manipulating an input component of the portable electronic device exemplifies the device, as an input target, receiving input from the user. Note that the user in providing input is detecting sensory information from the portable electronic device provided that the user directs sufficient attention to be aware of the sensory information and provided that no disabilities prevent the user from processing the sensory information. An interaction may include an input from the user that is detected and/or otherwise sensed by the device. An interaction may include sensory information that is detected by a user included in the interaction that is presented by an output device included in the interaction.

As used herein “interaction information” refers to any information that identifies an interaction and/or otherwise provides data about an interaction between a user and an object, such as a portable electronic device. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction. The term “operational component” of a device, as used herein, refers to a component included in performing an operation by the device.

Interaction information for one object may include and/or otherwise identify interaction information for another object. For example, a motion detector may detect user's head turn in the direction of a display of a portable electronic device. Interaction information identifying the user's head is facing the display may be received and/or used as interaction information for the portable electronic device indicating the user is receiving visual input from the display. The interaction information may serve to indicate a lack of user interaction with one or more other objects in directions from the user different than the detected direction, such as a person approaching the user from behind the user. Thus the interaction information may serve as interaction information for one or more different objects.

The term “attention information” as used herein refers to information that identifies an attention output and/or that includes an indication to present an attention output. Attention information may identify and/or may include presentation information that includes a representation of an attention output, in one aspect. In another aspect, attention output may include a request and/or one or more instructions for processing by a processor to present an attention output. The aspects described serve merely as examples based on the definition of attention information, and do not provide an exhaustive list of suitable forms and content of attention information.

As used herein the term “attention criterion” refers to a criterion that when met is defined as indicating that interaction between a user and an object is or maybe inadequate at a particular time and/or during a particular time period. In other words, the user is not directing adequate attention to the object.

As used herein, the term “tag” refers to a character string, which may include one or more words, which may be associated with a resource to create an association between the resource and another resource also tagged with the tag. Tags are often used in sharing media, social bookmarking, social news and blog entries to help users search for associated content. In some contexts, the term “tagging” as used herein refers to the process of associating a tag with a resource that can be tagged. As used herein, the term “tagged association” refers to an association that identifies a tag and a resource that is tagged with the tag. A resource is said to be “tagged” with a tag when a tagging process, also referred to as “tagging”, has successfully created a tagged association. In other contexts, a “tagging” refers to a tagged association.

The term “matched tag”, as used herein, refers to an association that identifies a tag and a tagging criterion, where the tagging criterion is based on data other than the tag. The tagging criterion may be based additionally on the tag. The term “tagging association”, as used herein, refers to a matched tag represented in a memory, either persistent and/or volatile. For example, a tagging association may be realized as a record that includes and/or identifies a tag and a tagging criterion. The terms “matched tag” and “tagging association” are used interchangeably. When the term “matched tag” refers to something other than its tagging association, it will be made clear. For example, a reference to matched tag presented in a user interface clearly identifies a UI element that identifies and/or otherwise represents and/or otherwise identifies a matched tag either realized or to be realized in a tagging association. A tagged association, defined above, may identify a matched tag and a resource that is tagged with the tag identified by the matched tag. Such an association is also referred to herein as a “matched tag association”. A resource may be tagged with a matched tag when a tagging criterion identified by the matched tag is met for the resource.

As user herein, the term “vocabulary” refers to a set of valid values that can be assigned to and/or included in a data element. With respect to a tag, a vocabulary defines valid tags. A vocabulary may be specified by one or more rules and/or by identifying one or more valid values directly and/or indirectly.

As used herein, the term” dictionary” refers a vocabulary wherein one or more terms in the vocabulary is assigned a definition. A “definition” as the term is used herein refers to information that identifies semantic information about a data value, such as a t tag. Semantic information may include one or more of a textual description of a meaning of the term, an audio description, a visual description, and information identifying a use or context for the term. A use and/or context may be identified, for example, by identifying a part of speech, a dialect or language, an antonym, a synonym, and/or an example usage of the defined data value.

As used herein, any reference to an entity “in” an association is equivalent to describing the object as “identified” by the association, unless explicitly indicated otherwise.

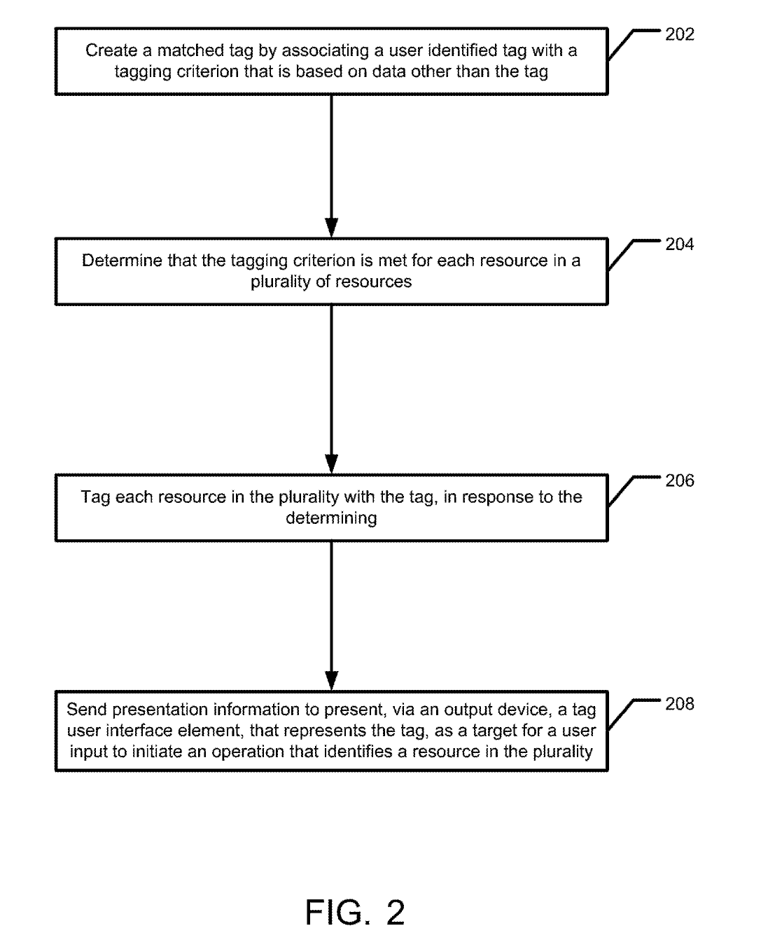

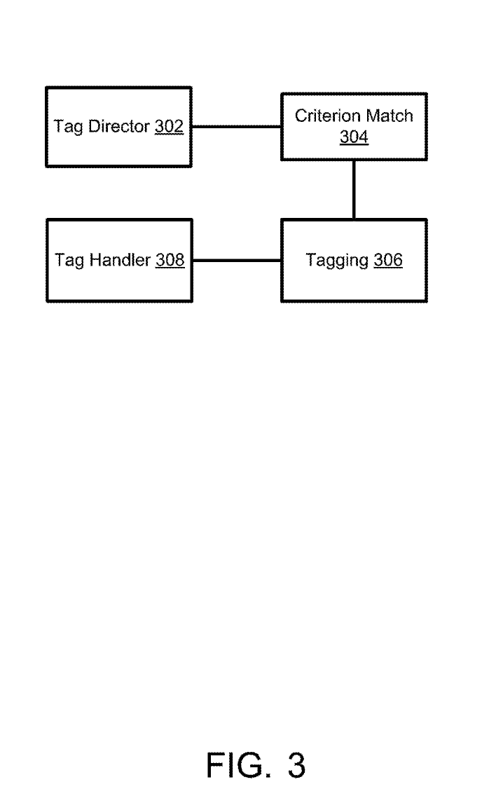

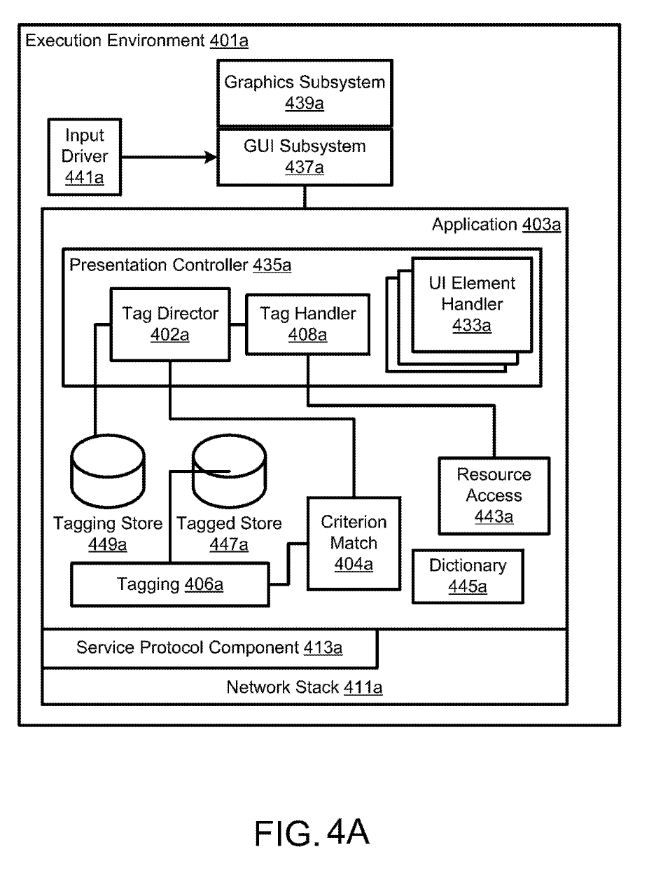

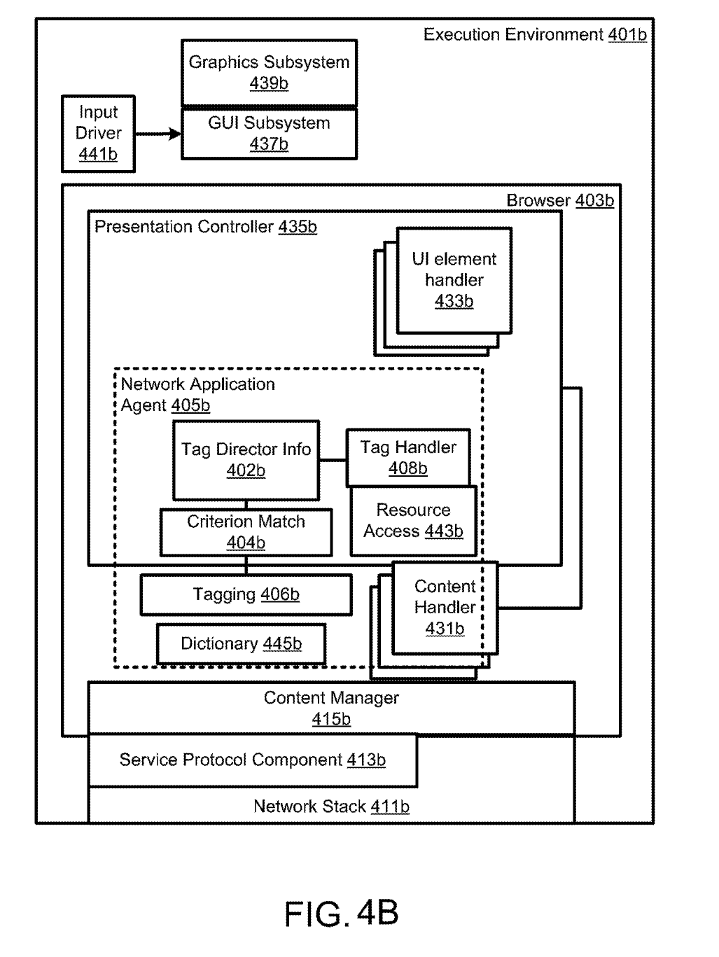

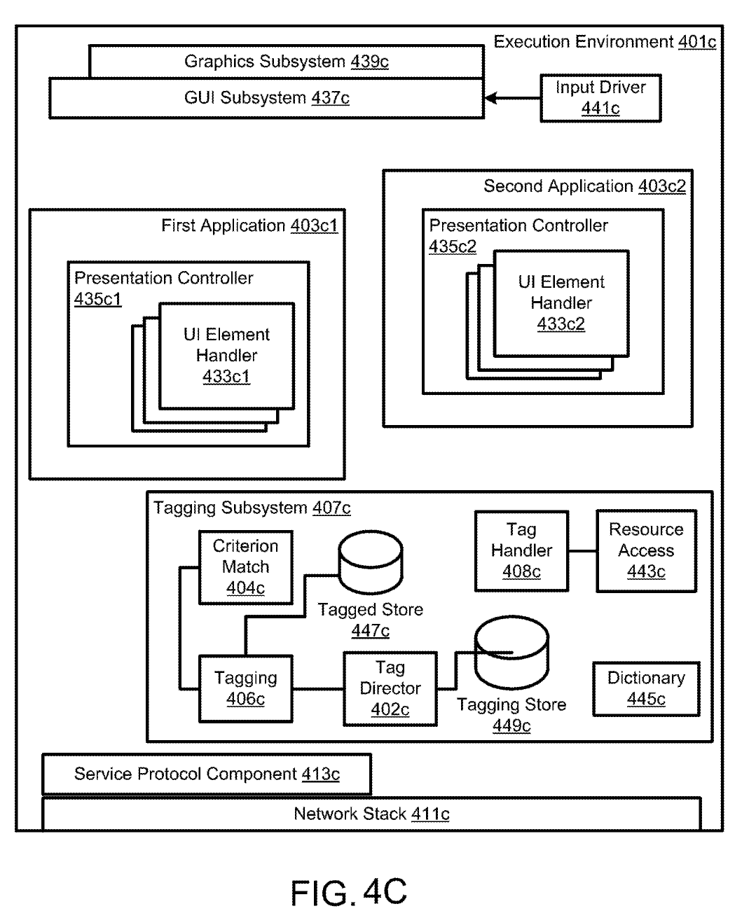

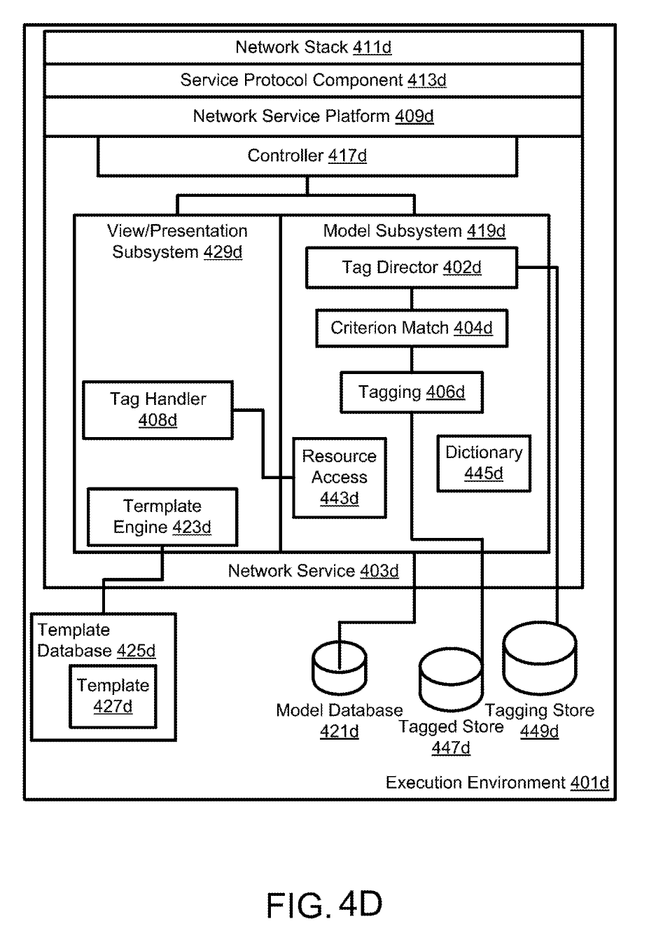

FIG. 3 illustrates an arrangement of components in a system that operates in an execution environment, such as execution environment 102 in FIG. 1, to perform the method illustrated in FIG. 2. The system illustrated includes a tag director component 302, a criterion match component 304, a tagging component 306, and a tag handler component 308. A suitable execution environment includes a processor, such as processor 104, to process an instruction in at least one of a tag director component, a criterion match component, a tagging component, and a tag handler component. Some or all of the exemplary components illustrated in FIG. 3 may be adapted to operate in a number of execution environments to perform the method illustrated in FIG. 2. FIGS. 4A-D are each block diagrams illustrating the components of FIG. 3 and/or analogs of the components of FIG. 3 respectively adapted to operate in an execution environment 401a, an execution environment 401b, an execution environment 401c, and an execution environment 401d that each include and/or otherwise are provided by one or more nodes. Components, illustrated in FIGS. 4A-D, are identified by numbers with an alphanumeric suffix. A component may be referred to generically in the singular or the plural by dropping a suffix of a portion thereof of the component's identifier. Execution environments; such as execution environment 401a, execution environment 401b, execution environment 401c, execution environment 401d, and their adaptations and analogs; are referred to herein generically as an execution environment 401 or execution environments 401 when describing more than one. Other components identified with an alphanumeric suffix may be referred to generically or as a group in a similar manner.

FIG. 1 illustrates key components of an exemplary device that may at least partially provide and/or otherwise be included in an execution environment. The components illustrated in FIGS. 4A-D may be included in or otherwise combined with the components of FIG. 1 to create a variety of arrangements of components according to the subject matter described herein.

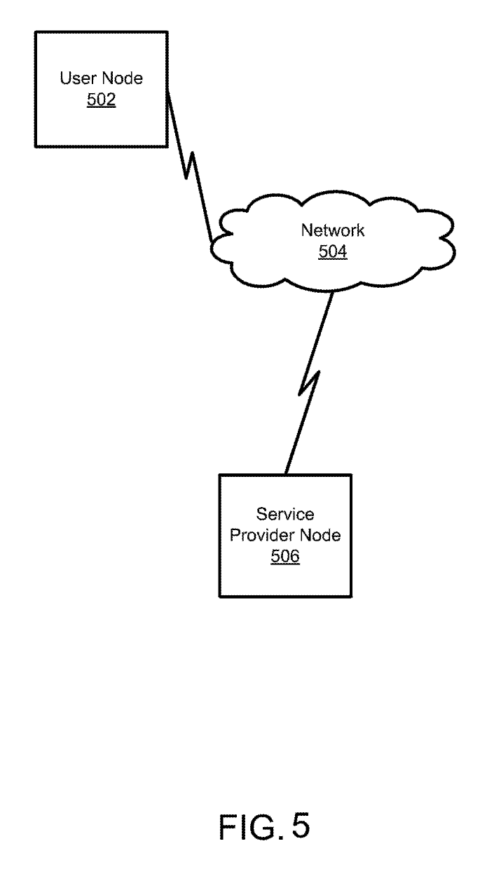

FIG. 5 illustrates a user node 502 as an exemplary device that in various aspects may be included in and/or otherwise adapted to provide any execution environment 401 illustrated in FIGS. 4A-C each illustrating a different adaptation of the arrangement of components in FIG. 3. In an aspect, a user node may be included in and/or otherwise host an execution environment 401d and/or an analog of execution environment 401d. As illustrated in FIG. 5, user node 502 is operatively coupled to a network 504 via a network interface component, such as network interface adapter 114. Alternatively or additionally, an adaptation of an execution environment 401 may include and/or may otherwise be provided by a device that is not operatively coupled to a network. A server device is illustrated by a service provider node 506. Service provider node 506 may be included in and/or otherwise provide execution environment 401d illustrated in FIG. 4D and/or an analog of execution environment 401d. In an aspect, a service provider node may be included in and/or otherwise host any execution environment 401 and/or an analog of any execution environment 401 illustrated in FIGS. 4A-C. As illustrated in FIG. 5, service provider node 506 is operatively coupled to network 504 via a network interface component included in execution environment 401d. Thus, service provider node 506 is communicatively coupled to one or more user nodes and/or other service provider nodes.

FIG. 4A illustrates that execution environment 401a hosts an application 403a that includes an adaptation of the arrangement of components in FIG. 3. FIG. 4B illustrates execution environment 401b hosting a browser 403b including an adaptation of the arrangement of components in FIG. 3 that may operate at least partially in a network application agent 405b received from a remote application provider, such as a network service 403d in FIG. 4D. Browser 403b and execution environment 401b may provide at least part of an execution environment for network application agent 405b that may be received via network 504 from network service 403d operating in service provider node 506. FIG. 4C illustrates an arrangement of the components in FIG. 3 adapted to operate in a tagging subsystem 407c in execution environment 401c.

FIG. 4D illustrates execution environment 401d which may host one or more network services, such as a web application, illustrated by network service 403d. FIG. 4D also illustrates a network service platform 409d that may provide services to one or more network services. Network service 403d includes yet another adaptation of the arrangement of components in FIG. 3.

As stated the various adaptations of the arrangement in FIG. 3 are not exhaustive. For example, those skilled in the art will see based on the description herein that arrangements of components for performing the method illustrated in FIG. 2 may operate in a single device, or may be distributed across more than one node in a network and/or more than one execution environment. For example, an arrangement may operate at least partially in browser 403b illustrated in FIG. 4B and at least partially in execution environment 401d in and/or external to network service 403d.

FIGS. 4A-D illustrate network stacks 411 that operate to send and receive data over network 504, via a network interface component. Network service platform 409d in FIG. 4D provides services to one or more network services. In various aspects, network service platform 409d may include and/or interoperate with a web server. FIG. 4D also illustrates network service platform 409d in operation interoperates with a network stack 411d.

Interoperating network stacks 411 may support the same protocol suite, such as TCP/IP, or may communicate via a network gateway or other protocol translation device and/or service. For example, browser 403b in FIG. 4B and network service platform 409d in FIG. 4D may interoperate via their respective network stacks: a network stack 411b and network stack 411d.

FIGS. 4A-D illustrate applications 403, respectively, which may communicate via one or more service protocols. FIGS. 4A-D respectively illustrate service protocol components 413 that operate to communicate via one or more service protocols. Exemplary service protocols include hypertext transfer protocol (HTTP), remote procedure call (RPC) protocols, instant messaging protocols, and presence protocols. Matching protocols enabling applications 403 to communicate via network 504 in FIG. 5 are not required, if communication is via a protocol gateway or other translator.

FIG. 4B illustrates that a browser may receive some or all of a network application agent in one or more messages sent from a network service, such as network service 403d, via a network service platform 409, a network stack 411, a network interface component, and optionally a service protocol component 413. In FIG. 4B, browser 403b includes a content manager component 415b. Content manager component 415b may interoperate with one or more of service protocol components 413b and/or network stack 411b to receive the message or messages including some or all of a network application agent 405b.

A network application agent 405 may include a web page for presenting a user interface for and/or otherwise based on data from a corresponding network service. The web page may include and/or reference data represented in one or more formats including hypertext markup language (HTML) and/or other markup language, ECMAScript or other scripting language, byte code, image data, audio data, and/or machine code.

In an example, in response to a request received from browser 403b, a controller component 417d, in FIG. 4D, may invoke a model subsystem 419d to perform request-specific processing. Model subsystem 419d may include any number of request handlers (not shown) that operate to dynamically generate data and/or to retrieve data from a model database 421d based on the request. Controller component 417d may further invoke a template engine component 423d to identify one or more templates and/or static data elements to generate a user interface to present a response to the received request. FIG. 4D illustrates a template database 425d including an exemplary template 427d. FIG. 4D illustrates template engine component 425d as a component in a view subsystem 429d that operates to return responses to processed requests in a presentation format suitable for a client, such as browser 403b. View subsystem 429d may provide the presentation data to controller component 417d to send to browser 403b in response to the request received from browser 403b. Some or all of a network application agent may be sent to a browser via a network service platform, as described above.

While the example describes sending some or all of a network application agent in response to a request, network service 403d additionally or alternatively may send some or all of network application agent 405b to browser 403b via one or more asynchronous messages. In an aspect, an asynchronous message may be sent in response to a change detected by network service 403d. Publish-subscribe protocols, such as the presence protocol specified by XMPP-IM, are exemplary protocols for sending messages asynchronously.

The one or more messages including information representing some or all of network application agent 405b illustrated in FIG. 4B may be received by content manager component 415b via one or more of service protocol component(s) 413b and network stack 411b as described above. In FIG. 4B, browser 403b includes one or more content handler components 431b to process received data according to its data type, typically identified by a MIME-type identifier. Exemplary content handler components 431b include a text/html content handler component for processing HTML documents; an application/xmpp-xml content handler component for processing XMPP streams including presence tuples, instant messages, and publish-subscribe data as defined by various XMPP specifications; one or more video content handler components for processing video streams of various types; and still image data content handler components for processing various images types. Content handler components 431b process received data and may provide a representation of the processed data to one or more user interface (UI) element handler components 433b.

UI element handler components 433 are respectively illustrated in presentation controller components 435 in FIGS. 4A-C. A presentation controller component 435 may manage visual, audio, and/or other types of output of its including application 403 as well as receive and route detected user and other inputs to components and extensions of its including application 403. With respect to FIG. 4B, a UI element handler component 433b in various aspects may be adapted to operate at least partially in a content handler component 431 b such as a text/html content handler component and/or a script content handler component. Additionally or alternatively, a UI element handler component 433 in an execution environment 401 may operate in and/or as an extension of its including application 403. For example, a plug-in may provide a virtual machine, for a UI element handler component 433 received as a script and/or byte code, that may operate as an extension in an application 403 and/or external to and interoperating with the application 403.

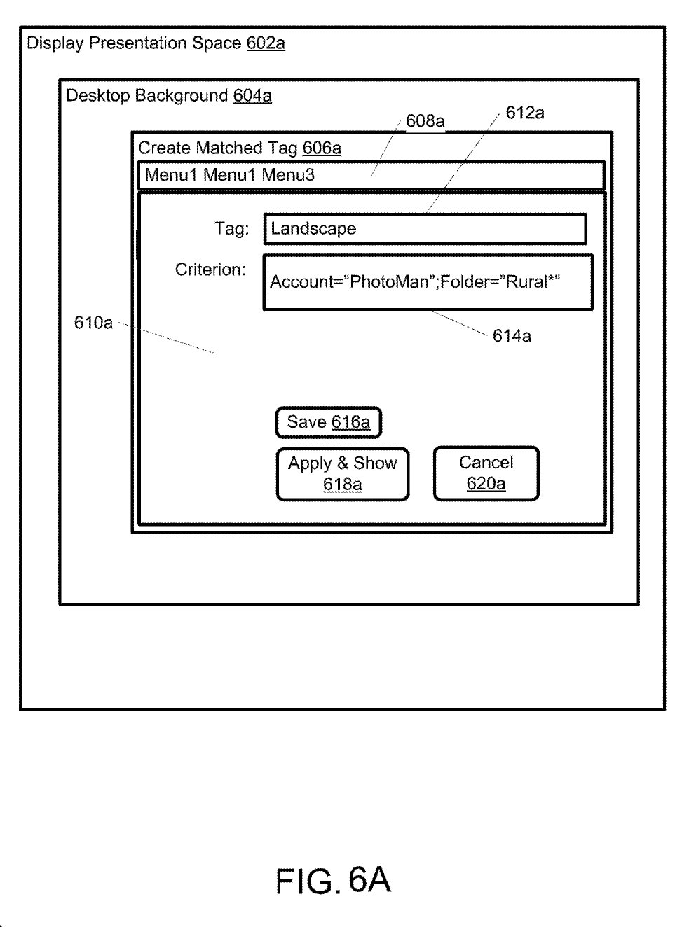

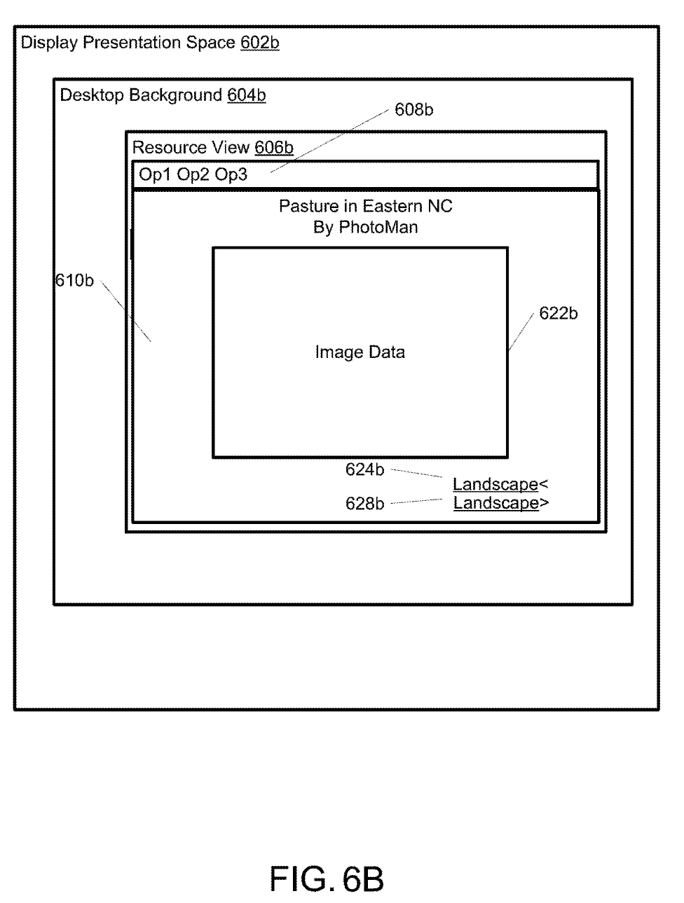

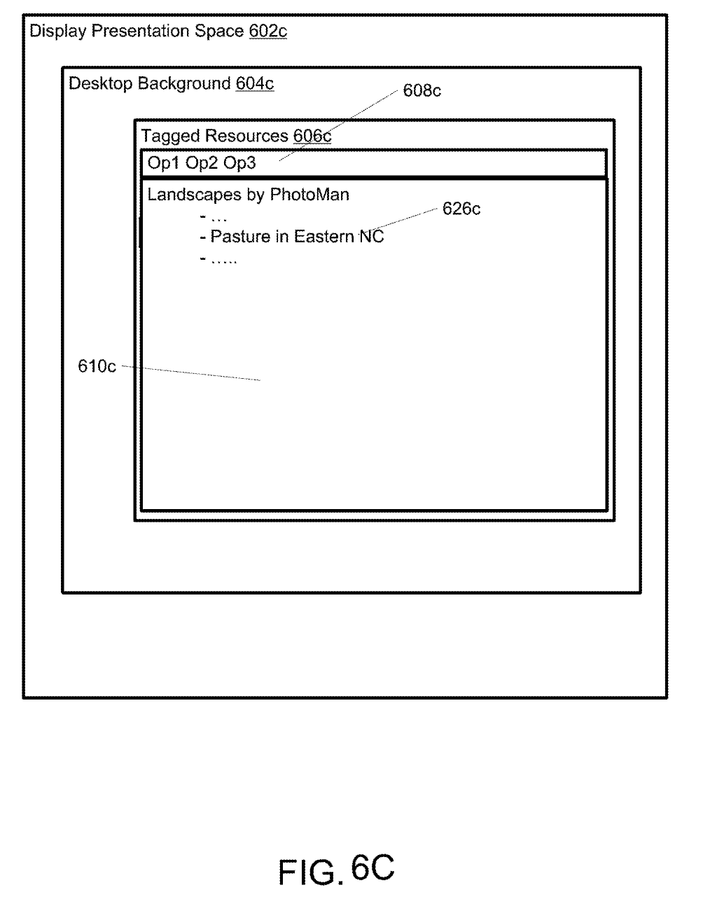

FIGS. 6A-C each respectively illustrates a display presentation space 602 of a display in and/or operatively coupled to a node, such as user node 502. FIGS. 6A-C each respectively illustrates a desktop background 604 that may be a still image and/or a video background. An application window 606 is illustrated in each of FIGS. 6A-C. An application window 606 is a UI element presented that may provide and/or be included in a user interface for any of applications 403 illustrated in FIGS. 4A-D and/or by a network application agent. For example, application window 606 may be presented via interoperation of browser 403b, network application agent 405b, and/or network service 403d. A browser window may include a user interface of network service 403d operating in service provide node 506.

Various UI elements of applications 403 described above may be presented by one or more UI element handler components 433 in FIGS. 4A-C and/or by view subsystem 429d as illustrated in FIG. 4D. In an aspect, illustrated in FIGS. 4A-C, A UI element handler component 433 of one or more applications 403 may operate to send presentation information representing a UI element, such as any of the visual components in any of the application windows 606 in FIGS. 6A-C, to a GUI subsystem 437. A GUI subsystem 437 may instruct a graphics subsystem 439 to draw and/or otherwise store the UI element in a region of a display presentation space 602, based on presentation information received from the corresponding UI element handler component 433.

User input may be received corresponding to a UI element via an input driver 441 illustrated in FIGS. 4A-C in various adaptations. For example, a user may move a mouse to move a pointer presented in a display presentation space 602 over a UI element. A user may provide an input detected by the mouse. The detected input may be received by a GUI subsystem 437 via an input driver 441 as an operation or command indicator based on the association of the shared location of the pointer and the UI element in the display presentation space 602.

With reference to FIG. 2, a block 202 illustrates that the method includes creating a matched tag by associating a user identified tag with a tagging criterion that is based on data other than the tag. Accordingly, a system for tagging a resource includes means for creating a matched tag by associating a user identified tag with a tagging criterion that is based on data other than the tag. For example, the arrangement in FIG. 3, includes tag director component 302 that is operable for creating a matched tag by associating a user identified tag with a tagging criterion that is based on data other than the tag. FIGS. 4A-D illustrate tag director components 402 as adaptations and/or analogs of tag director component 302 in FIG. 3. One or more tag director components 402 operate in an execution environment 401. The system for tagging a resource includes one or more processors and logic encoded in one or more tangible media for execution by the one or more processors that when executed is operable for creating a matched tag by associating a user identified tag with a tagging criterion that is based on data other than the tag.

In FIG. 4A, a tag director component 402a is illustrated as a component of application 403a. In FIG. 4B, a tag director component 402b is illustrated as a component of network application agent 405b. In FIG. 4C, a tag director component 402c is illustrated operating external to one or more applications 403c. Execution environment 401c includes a tag director component 402c in a tagging subsystem 407c. In FIG. 4D, a tag director component 402d is illustrated operating in network service 403d remote from a network agent communicatively coupled to network service 403d. In an aspect a tag director component 402b and a tag director component 402d may communicate via browser 403b and network service 403d in performing a portion of the method illustrated in FIG. 2 in block 202.

In various aspects, a tag director component 402 may receive tagging information based on input information from a UI element handler component 433. A user input may be detected that corresponds to a UI element presented to identify and/or otherwise represent a tag. A tag may be a user entered tag and/or otherwise a user selected tag. Further, criterion information identifying a tagging criterion may be received via the same or different UI element handler component 433, where the tagging criterion is based on something other than and/or in addition to the identified tag. In another aspect, a tagging criterion may be determined based on a user identified tag, by a UI element handler component 433 and/or by a tag director component 402, in response to a detected user input identifying the tag. The tag director component 402 may create a matched tag that identifies the tag and the tagging criterion. The matched tag is realized as a tagging association as defined above.

Execution environment 401a, in FIG. 4A, may be included in and/or otherwise may include a node, such as user node 502 illustrated in FIG. 5. Tagging information identifying a tag may be received by a UI element handler component 433a in response to a user input detected by an input driver 441a. Input information, such as information identifying a location in a presentation space of a display, may be provided by the input driver 441a to GUI subsystem 437a. Based on the input information, GUI subsystem 437a may identify application 403a and send the input information, to application 403a. GUI subsystem 437a may provide a component, such as presentation controller 435a that operates to route input information within application 403a to a UI element handler component 433a. The UI element handler component 433a may identify the tagging information based on the input information and may provide the tagging information to tag director component 402a. Alternatively or additionally, GUI subsystem 437a may provide input information directly to one or more UI element handlers 433a corresponding to one or more UI elements that GUI subsystem 437a has determined correspond to the detected user input. Criterion information identifying a tagging criterion may be received in an analogous manner via the same or different UI element handler component 433a, where the tagging criterion is based on something other than and/or in addition the identified tag. The UI element handler component 433a may identify the criterion information based on the input information and provide the criterion information to tag director component 402a. Tag director component 402a may create a matched tag that identifies the tag and the tagging criterion by creating a tagging association in tagging store 449a, which may include a database record and/or a file.

FIG. 6A depicts a user interface presented by an application 403 as described above for any of FIGS. 4A-D. The application 403 includes one or more UI element handlers 433 to present a create matched tag UI element 606a in presentation space 602a of a display device. Create matched tag UI element 606a is illustrated with a menu bar UI element 608a including input UI elements for receiving user input for various specified operations. Create matched tag UI element 606a includes a tagging pane UI element 610a to prompt a user to provide input to provide tagging information that identifies a tag. In FIG. 6A, a tag field UI element 612a is presented by a corresponding UI element handler component 433a allowing a user to specify a tag. Tagging pane UI element 608a also includes a criterion field UI element 614a to prompt the user to provide input to provide and/or otherwise identify criterion information identifying a tagging criterion based on data other than and/or in addition to the tag.

FIG. 6A illustrates, in criterion field UI element 614a, input information ‘Account=“PhotoMan”;Folder=“Rural”’ as criterion information provided by the user. An application 403 may operate to identify “PhotoMan” as a user account identifier The application may identify “Rural” as folder that includes one or more digital photographs. The folder may be a folder shared by multiple accounts. FIG. 6A also illustrates tagging information, in tag field UI element 610a, identifying “Landscape” as the user identified tag. The input information may be received by one or more UI element handler components 433 that correspond to tag field UI element 612a and criterion field UI element 614A. A tag director component 402 may receive the tagging information and the criterion information in response to a user input targeting a “Save” button UI element 616a and/or an “Apply & Show” button UI element 618a. The user may cancel providing tagging information and criterion information by directing an input to a “Cancel” button UI element 620a.

An arrangement of components in execution environment 401b illustrated in FIG. 4B, may operate to perform equivalently in creating a matched tag. Execution environment 401b may also include and/or otherwise be included in a node, such as a user node 502 illustrated in FIG. 5. In FIG. 4B, a UI element handler component 433b and/or a presentation controller component 435b may receive input information corresponding to a presented user interface element for identifying tagging information. The input information may be provided to the UI element hander component 433b for processing. The UI element handler component 433b may perform all or some of the processing and/or may send a request to a remote service, such as network service 403d operating in execution environment 401d of a service provider node 506, via a network, such as network 504. Some or all of the processing of the input information may be performed in execution environment 401d to identify and/or otherwise determine tagging information identifying a tag. Criterion information may be identified and/or otherwise determined analogously. One or more UI element handler components 433b and/or UI element handler components 433d may provide tagging information and optionally criterion information to one or both of tag director component 402b operating in execution environment 401b and/or to tag director component 402d in execution environment 401d to create a matched tag.

FIG. 4D illustrates, in an aspect, tag director component 402d in a model subsystem 419d in execution environment 401d, which may be included in and/or otherwise may include service provider node 506 in FIG. 5. A UI element handler component 433b for presenting and/or receiving input identifying tagging information and/or a UI element handler component 433b for presenting and/or for receiving input identifying criterion information may operate in browser 403b in execution environment of user node 502. A message based on the input information corresponding to a UI element presented by the tagging information UI element handler component 433b and/or the criterion information UI element handler component 433b may be transmitted by browser 403b to network service 403d operating in execution environment 401d of service provider node 506 via network 504. Tag director component 402d may be invoked in response to the message by a request handler (not shown) in model subsystem 419d. Tag director component 402d may receive tagging information and/or otherwise may receiving information based on the message to identify tagging information. Browser 403b and/or network application agent 405b may send the message via user node 502 communicatively coupled to network 504 to service provider node 506 for delivery to network service 403d. Controller component 417d may receive at least some portion of the message. Based on the message or portion thereof, such as a URI, controller component 417d may route information in the message to a request handler (not shown) in model subsystem 419d. Tag director component 402d may include, may be included in, and/or may otherwise interoperate with the request handler identified by controller component 417d. Tag director component 402d may identify a tag based on the tagging information received and/or otherwise identified. Tag director component 402d may identify a tagging criterion analogously, based on input detected by browser 403b in execution environment 401b of user node 502. Tag director component 402d may create a matched tag identifying the tag and the tagging criterion. For example, in an aspect, tag director component 402d may store a tagging association for the matched tag in one or more records and/or locations in tagging store 449d.

The arrangement of components operating in execution environment 401c, illustrated in FIG. 4C, may also perform the operations described above and/or analogous operations. Execution environment 401c and/or analog of execution environment 401c may be provided by and/or otherwise my include one or more nodes, such as a user node 502. Input processing in execution environment 401c in FIG. 4C may be performed for more than one application 403c by a subsystem illustrated by tagging subsystem 407c. In an aspect, a UI element handler component 433c and/or a presentation controller component 435c operating in an application 403c may receive input information corresponding to a presented item to identify tagging information and/or to identify criterion information. The UI element handler component 433c may operate in an application, such a first application 403c 1 or a second application 403c2 as shown in FIG. 4C. Alternatively or additionally, an application 403c may interoperate with a UI element handler component, which may be included in a tag handler component 408c, provided by tagging subsystem 407c. A UI element handler 433c1 in first application 403c1 may interoperate with a UI element handler component in tagging subsystem 407c in receiving input information to provide tagging information and/or criterion information to tag director component 402c. A user input may be detected by an input driver 441c. Input information, such as information identifying a location with respect to a presentation space, may be provided by the input driver 441c to a GUI subsystem 437c. Based on the input information, GUI subsystem 437c may identify an application 403c and send selection information, based on the input information, to the application 403c. GUI subsystem 437c may provide input information to a component, such as a presentation controller 435c1 to route the input information within first application 403c1 for processing. Alternatively or additionally, GUI subsystem 437c may provide input information directly to one or more UI element handlers 433c corresponding to one or more UI elements that GUI subsystem 437c determines corresponds to the detected user input. Tag director component 403c creates a matched tag identifying the tag and the tagging criterion. For example, in an aspect, tag director component 402d may store a tagging association for the matched tag in a storage location in a processor memory and/or in a persistent secondary storage location in tagging store 449c.

Returning to FIG. 2, a block 204 illustrates that the method further includes determining that the tagging criterion is met for each resource in a plurality of resources. Accordingly, a system for tagging a resource includes means for determining that the tagging criterion is met for each resource in a plurality of resources. For example, the arrangement in FIG. 3, includes criterion match component 304 that is operable for determining that the tagging criterion is met for each resource in a plurality of resources. FIGS. 4A-D illustrate criterion match components 404 as adaptations and/or analogs of criterion match component 304 in FIG. 3. One or more criterion match components 404 operate in an execution environment 401. The system for tagging a resource includes one or more processors and logic encoded in one or more tangible media for execution by the one or more processors that when executed is operable for determining that the tagging criterion is met for each resource in a plurality of resources.

In FIG. 4A, a criterion match component 404a is illustrated as a component of application 403a. In FIG. 4B, a criterion match component 404b is illustrated as a component of network application agent 405b. In FIG. 4C, a criterion match component 402c is illustrated operating external to one or more applications 403c. Execution environment 401c includes a criterion match component 404c in tagging subsystem 407c. In FIG. 4D, a criterion match component 402d is illustrated operating in network service 403d remote from a network agent communicatively coupled to the network service 403d. In an aspect criterion match component 404b and criterion match component 404d communicate via browser 403b and network service 403d in performing a portion of the method illustrated in FIG. 2 in block 204.

In an aspect, an operation may be performed to determine whether a tagging criterion is met for a resource, in response to detecting an access to the resource. Detecting an access to a resource may be direct and/or indirect. Further detecting an access to a resource may include detecting an indication that a resource is to be accessed, detecting a resource while it is accessed, and/or identifying a resource prior to, during, and subsequent to an access, to the resource.

With respect to FIG. 4A-D, an application 403 may access a resource, in response to a request to present a listing of resources in a folder in a file system, data base, and/or other data repository that includes the particular resource. A criterion match component 404 may be invoked, in response to accessing the resource and/or an identifier of the resource. A tag director component 402 may interoperate with the criterion match component 404 to identify a tagging criterion identified by a matched tag. The criterion match component 404 may determine whether the tagging criterion is met for the resource. The tagging criterion is based on data associated with the resource other than and/or in addition to the tag. For example, the tagging criterion may specify a threshold criterion for measuring a playing duration of a video stream. A criterion match component 404 may operate to access video stream play duration information from metadata in and/or otherwise associated with a video file in order to evaluate the tagging criterion. The criterion match component 404 may determine that the tagging criterion is met. This process may be repeated in response to accessing each resource. A criterion match component 404 may detect that the tagging criterion is met for a plurality of resources. In the playing duration example, the matched tag identifying the tagging criterion may identify the tag “movie” or “feature length”. When the threshold is exceeded, the tagging criterion may be specified to indicate the criterion is met when evaluated for a particular video file.

In FIG. 4A, application 403a may access a particular resource, in response to a request to present a listing of resources in a folder in a file system, data base, and/or other data repository that includes the particular resource. Criterion match component 404a may be invoked, in response to accessing the resource and/or in response to accessing an identifier of the resource. A tagging criterion identified by a matched tag created by tag director component 402a, in an instance of execution environment 401a, may be identified to and/or otherwise received by criterion match component 404a. Criterion match component 404a may determine whether the tagging criterion met for the resource. The tagging criterion is based on data associated with the resource other than and/or in addition to the tag in the matched tag. Criterion match component 404a may operate to access metadata associated with the resource in order to evaluate a tagging criterion. For example, the tagging criterion may be based on a time of day the resource is accessed. Criterion match component 404a may determine that the tagging criterion is met. This process may be repeated in response to accessing each resource in the identified data repository. Criterion match component 404a may detect that the tagging criterion is met for zero or more of the resources.

Returning to the example described above with respect to FIG. 6A, an application 403 may access images in a system of folders, which may or may not have sub-folders, such as file system and/or a photo-sharing service. A criterion match component 404 may be invoked, in response to accessing each of the images to determine whether a tagging criterion identified by criterion information received from a user via criterion field UI element 614a in FIG. 6A is met for each resource. The tagging criterion may be specified so that it is met when an image is in an account of a user authenticated with the user identifier, “PhotoMan”, and when the image has included in a folder named and/or otherwise categorized as “Rural”. The user with the “Photoman” user account identifier, may know that all of his/her images in the identified folder are landscapes. The tagging criterion may be identified by a tag director component 402 to the criterion match component 404, directly and/or indirectly. The criterion match component 404 may determine whether the tagging criterion is met for each image in the folder and any subfolders. The criterion match component 404 may operate to receiving account information and folder information for each image accessed in order to evaluate the tagging criterion. If an image from the “Rural” folder is included in the account of “Photoman”, the criterion match component 404 determines that the tagging criterion is met. This process may be repeated in response to accessing each image. The criterion match component 404 may detect that the tagging criterion is met for a zero or more images.

In FIG. 4B, the arrangement of components may perform the same operation and/or analogous operations. Browser 403b operating in execution environment 401b of user node 502, in FIG. 5, may access a particular resource, in response to a request to present and/or otherwise process the particular resource. Criterion match component 404b may be invoked, in response to accessing the resource and/or an identifier of the resource. A tagging criterion identified by tag director component 402b may be provided to and/or otherwise identified by criterion match component 404b to identify a tagging criterion. Criterion match component 404b may determine whether the tagging criterion is met for the resource. For example, criterion match component 404b may operate to identify a role of a user of browser 403b when the tagging criterion is based on a user role. Criterion match component 404b may determine that the tagging criterion is met. This process may be repeated in response to accessing each resource accessed and/or otherwise identified.

With respect to the arrangement of components in FIG. 4D, a browser in a user node, may access and/or otherwise identify one or more resources in performing a specified task. Criterion match component 402d may be invoked, in response to network service 403d detecting an access to a specific resource and/or an identifier of a specific resource in performing the task. The browser operating in the user node may invoke the criterion match component 401d by sending a message, via a network such as network 504, to network service 403d in execution environment 401d of service provider node 506. The message and/or information based on the message may be routed and/or made available to criterion match component 404d. In an aspect, criterion match component 404b in execution environment 401b of user node 502 may be included in exchanging and/or otherwise processing one or more messages exchanged between browser 403b and network service 403d. A tagging criterion identified by one or both of tag director component 402b and tag director component 402d may be identified to criterion match component 404d. In the aspect, the tagging criterion may also be identified and/or made available to criterion match component 404b. Criterion match component 404d may determine whether the tagging criterion is met for the resource. For example, criterion match component 404d may determine whether the role of the user of browser 403b matches a role or a criterion for a role specified in the tagging criterion. Criterion match component 404d may determine that the tagging criterion is met.

The arrangement of components in FIG. 4C operating in a node may also perform the same or analogous operations as described above. An application 403c may access and/or identify a particular resource. Criterion match component 404c in tagging subsystem 407c may be invoked, in response to accessing and/or identifying the resource. A tagging criterion in a tagging association may be identified by tag director component 402c. Tag director component 402c may provide and/or otherwise identify the criterion information to criterion match component 404c. Criterion match component 404c may determine whether the tagging criterion is met for the particular resource. For example, a matched tag may identify a tag “Education” and may identify a tagging criterion, as a regular expression, that matches an identifier for an educational institution, such as a regular expression.*(College/University) that matches any string that ends with “College” or “University”. The tagging criterion may further specify that for resources such as online books, videos, and/or audio resources an owner metadata field and/or a creator metadata field is to be matched based on the regular expression. Criterion match component 404c may operate to access specified metadata associated with the resource in order to evaluate the tagging criterion. Criterion match component 404c may determine that the tagging criterion is met.

Returning to FIG. 2, a block 206 illustrates that the method yet further includes tagging each resource in the plurality with the tag, in response to the determining. Accordingly, a system for tagging a resource includes means for tagging each resource in the plurality with the tag, in response to the determining. For example, the arrangement in FIG. 3, includes tagging component 306 that is operable for tagging each resource in the plurality with the tag, in response to the determining. FIGS. 4A-D illustrate tagging components 406 as adaptations and/or analogs of tagging component 306 in FIG. 3. One or more tagging components 406 operate in an execution environment 401. The system for tagging a resource includes one or more processors and logic encoded in one or more tangible media for execution by the one or more processors that when executed is operable for tagging each resource in the plurality with the tag, in response to the determining.

In FIG. 4A, a tagging component 406a is illustrated as a component of application 403a. In FIG. 4B, a tagging component 406b is illustrated as a component of network application agent 405b. In FIG. 4C, a tagging component 406c is illustrated operating external to one or more applications 403c. Execution environment 401c includes a tagging component 406c in tagging subsystem 407c. In FIG. 4D, a tagging component 406d is illustrated operating in network service 403d remote from a network agent communicatively coupled to the network service 403d. In an aspect tagging component 406b and tagging component 406d communicate via browser 403b and network service 403d in performing a portion of the method illustrated in FIG. 2 in block 206.

With respect to FIG. 4A-D, a criterion match component 404 determines that a tagging criterion is met for a resource. The criterion match component 404 may invoke, directly and/or indirectly, a tagging component 406 and identify the resource, the tag, and optionally the tagging criterion to the tagging component 406. The tagging component 406 may tag the resource by creating a tagged association that identifies the resource and the matched tag.

In an aspect and referring to FIG. 4A, tagging may be performed automatically in response to identifying that a tagging criterion in a matched tag is met for a resource. With respect to FIG. 4A when criterion match component 404a determines that a tagging criterion, in a matched tag, is met for a resource, criterion match component 404a may invoke, directly and/or indirectly, tagging component 406a identifying the resource and the tag, identified by the matched tag, to tagging component 406a. In an aspect, tagging component 406a may also receive and/or otherwise identify the tagging criterion in the matched tag. Tagging component 406a may create a tagged association that identifies the resource and the matched tag, in tagging the resource with the tag. The tagged association may be stored in a processor memory for a duration of time of a particular task, such as the presentation of the resource and the tag. When the presentation ends, the tagged association may be deleted and/or otherwise destroyed. When the resource is accessed again, criterion match component 404a may be invoked again to determine whether the tagging criterion is met for the resource. If the data that the tagging criterion is based on has changed, the tagging criterion might not be met, for the resource. If the tagging criterion is met, criterion match component 404a may again invoke tagging component 406a to once again tag the resource be creating a tagged association.

Returning to the example described above with respect to FIG. 6A, when criterion match component 404a determines that the tagging criterion identified by criterion information received via criterion field UI element 614a in FIG. 6A is met for an image in the “Rural” folder, criterion match component 404a may invoke tagging component 406a providing and/or otherwise identifying the image and the tag, “Landscape”, to tagging component 406a. Tagging component 406a may operate to create a tagged association that identifies the image and the matched tag.

In an aspect and referring to FIG. 4B, tagging may be performed automatically in response to creating a matched tag and, thus, automatically in response to identifying that a tagging criterion in the matched tag is met for a resource. Tagging component 406b, in browser 403b in execution environment 401b of a user node 502, may be invoked in response to criterion match component 404b and/or criterion match component 404d, in execution environment 401d of service provider node 506, determining that a tagging criterion, identified by the matched tag, is met for the resource, Tagging component 406b may create a tagged association to tag the resource with the tag and the matched tag. Tagging component 406b may interoperate with tagging component 406d in execution environment 401d of service provider node 506 via network 504, to create the tagged association. The tagged association may be stored in tagged store 447d by one or both of browser 403b and network service 403d. As described above, a tagged association may be stored in a volatile data storage medium and/or in a persistent data storage medium.

With respect to FIG. 4D in an aspect, tagging component 406d is illustrated operating in model subsystem 419d in execution environment 401d which may be included in and/or otherwise include service provider node 506 in FIG. 5 as previously described. Criterion match component 404d may determine that a tagging criterion identified by a matched tag is met for a particular resource, as described above. Tagging component 406d may be invoked automatically to tag the resource, in response to determining that the tagging criterion is met. Alternatively or additionally, criterion match component 404b in browser 403b in execution environment 401b of user node 502 may determine that the tagging criterion is met for the resource. A message may be sent from browser 403b via network 504 to network service 403d to automatically invoke tagging component 406d to tag the resource with the tag identified by the matched tag. Tagging component 406d operating in execution environment 401d of service provider node 506 may be invoked in response to the message via a request handler (not shown) in model subsystem 419d. Tagging component 406d may identify, based on the message, the resource and the matched tag. Tagging component 406d may create a tagged association stored in a tagged store 447d accessible to execution environment 401d of service provider node 506 and/or may interoperate with tagging component 406b to create the tagged association, a copy of the tagged association, and/or a reference to the tagged association stored in a tagged store (not shown) in execution environment 401 b of user node 502.

The arrangement of components in execution environment 401c, may perform the same or analogous operations as the other arrangements described with respect to tagging a resource based on a matched tag. In FIG. 4C, tagging may be performed automatically as described herein with respect to FIG. 4A, FIG. 4B, and/or as described with respect to FIG. 4D. Tagging component 406c, in tagging subsystem 407c, may be invoked to tag a resource, for which a tagging criterion identified by a matched tag is met. Tagging component 406c is invoked to tag the resource with a tag identified by the matched tag. In an aspect, tagging component 406c may receive a matched tag via and/or otherwise in response to being invoked. Tagging component 406c may create a tagged association that identifies the resource and the tag and/or the matched tag, thus tagging the resource with the tag. The tagged association may be stored in a tagged store 447c accessible to multiple applications 403c operating in execution environment 401c. One or more tagged resources may be shared between and/or among applications 403c and /or one or more tagged resources and/or tags may be accessible only to a particular application 403c. In an aspect, tagging subsystem 407c may operate to control sharing of resources, tagging criterion, tags, and/or matched tags between and/or among applications 403c. The arrangement of components illustrated in FIG. 4D, may analogously be configured to control sharing of resources, tagging criterion, tags, and/or matched tags between and/or among user nodes communicatively coupled to a service provider node providing and/or part of execution environment 401d.

Returning to FIG. 2, a block 208 illustrates that the method yet further includes sending presentation information to present, via an output device, a tag user interface element, that represents the tag, as a target for a user input to initiate an operation that identifies a resource in the plurality. Accordingly, a system for tagging a resource includes means for sending presentation information to present, via an output device, a tag user interface element, that represents the tag, as a target for a user input to initiate an operation that identifies a resource in the plurality. For example, the arrangement in FIG. 3, includes tag handler component 308 that is operable for sending presentation information to present, via an output device, a tag user interface element, that represents the tag, as a target for a user input to initiate an operation that identifies a resource in the plurality. FIGS. 4A-D illustrate tag handler components 408 as adaptations and/or analogs of tag handler component 308 in FIG. 3. One or more tag handler components 408 operate in an execution environment 401. The system for tagging a resource includes one or more processors and logic encoded in one or more tangible media for execution by the one or more processors that when executed is operable for sending presentation information to present, via an output device, a tag user interface element, that represents the tag, as a target for a user input to initiate an operation that identifies a resource in the plurality.

In FIG. 4A, a tag handler component 408a is illustrated as a component of application 403a. In FIG. 4B, a tag handler component 408b is illustrated as a component of network application agent 405b. In FIG. 4C, a tag handler component 408c is illustrated operating external to one or more applications 403c. Execution environment 401c includes a tag handler component 408c in tagging subsystem 407c. In FIG. 4D, a tag handler component 408d is illustrated operating in a network service 403d remote from a network agent communicatively coupled to the network service 403d. In an aspect tag handler component 408b and tag handler component 408d communicate via browser 403b and network service 403d in performing a portion of the method illustrated in FIG. 2 in block 208.

With respect to FIG. 4A-D, an application 403 may access a resource. A UI element handler component 433 may operate to interoperate with a GUI subsystem 437 via a network and/or locally to present a UI element representing and/or otherwise identifying a tag, identified by a matched tag. A tag handler component 408, which may be and/or may otherwise include a UI element handler component 433, may be invoked to send presentation information to the GUI subsystem 437 to present, via a display and/or other output device, the UI element that represents and/or otherwise identifying the tag. The tag handler component 408 may be invoked, in response to a user input that targets and/or that otherwise corresponds to the UI element that represents and/or otherwise identifying the tag. In response to the user input, the tag handler component 437 may operate to locate one or more resources for which the tagging criterion identified by the matched tag is/or has been determined to be met. In an aspect, a UI element handler component 433 may operate to interoperate with the GUI subsystem 437 via a network and/or locally to present a resource, tagged with a tag identified by a matched tag, in a resource UI element. The tag may be presented along with the resource as described in the previous paragraph. The tag handler component 408 may operate to locate another resource tagged with the tag to present the other resource to the user.

In FIG. 4A, a request to present a resource may be detected by a UI element handler component 433a of application 403a. Application 403a may access, the resource, in responding to the user request. The UI element handler component 433a may interoperate with GUI subsystem 437a to represent and/or otherwise identify the resource in and/or otherwise by UI element. The UI element handler component 433a corresponding to the UI element representing the resource may include and/or otherwise interoperate with tag handler component 408a to present a UI element that identifies and/or otherwise represents one or more tags, identified by respective matched tags, by sending presentation information to GUI subsystem 437a as describe above to present UI element(s) identifying the one or more tags, along with the UI element that identifies the resource, as tag(s) for the resource. Tag handler component 408a may operate to process input information from a user. Tag handler 408a may operate to invoke a resource access component 443a. In one aspect, resource access component 443a may locate a second resource tagged with the tag in the matched tag. Alternatively or additionally, resource access component 443a may operate to invoke a search component (not shown) to perform a search based on the tagging criterion in a matched tag that identifies the tag. When the tagging criterion is met, as determined by criterion match component 404a, for a resource located during the search, the resource may be identified as tagged and/or may be tagged as described above via operation of one or more of tag director component 402a, criterion match component 404a, and tagging component 406a.

Returning once again to the example described above with respect to FIG. 6A, a request to present an image may be detected by a UI element handler component 433a of application 403a. In response to accessing the image, tag director component 402a of application 403a may be invoked to access the tagging criterion identified in criterion field UI element 614a and to provide the tagging criterion match component 404a. Criterion match component 404a may access the account owner of the image in determining whether the tagging criterion is met for the image. Criterion match component 404a may determine that the tagging criterion is met for the image when “PhotoMan” is identified as the account user identifier of the account associated with the image and when the image in in a folder that matches the tagging criterion. A UI element handler component 433a may present a UI element that identifies the image in a view pane UI element 610b of a resource view UI element 606b. The image representation is illustrated by image data UI element 622b. Application 403a may also identify the tag, “Landscape”, to tag handler component 408a to present a representation of the tag in a tag UI element 624a that identifies the tag. Other tags may be presented as well, in some aspects. Tag UI element 624b, in an aspect, may be represented as a link to invoke a search request performed by resource access component 443a. Tag handler component 408a may operate to process input information based on a user input that is directed to and/or otherwise targets tag UI element 624b. Tag handler 408a may operate to invoke a search component (not shown) to locate a second resource tagged with the tag. In an aspect, any resource tagged with “Landscape” may be located. In another aspect, illustrated in FIG. 6C resources that match the tag represented by tag UI element 624b in FIG. 6B and that match the tagging criterion specified in criterion information form field UI element 614a are located. FIG. 6C shows a tagged resources UI element 606c including a resource list pane UI element 610c. A list of images in the account of user, “PhotoMan”, and in matching folders are presented in a list UI element 626c in a presentation space of resource list pane UI element 610c. Items in the lists may be links or other input UI elements that when selected are processed by application 403a to display an instance of application window UI element 606b including a representation of the identified image and the representations of the one or more tags for the image. In the example, processing of the tagging criterion results in automatic tagging of resources in the account of a specific user. Selecting the tag in a UI interface may restrict the scope of a search for related resources to the account of the identified user as described in more detail below.

In FIG. 4B and FIG. 4D, a request to present a resource may be detected by a UI element handler component 433b of browser 403b operating in execution environment 401b in and/or otherwise including user node 502 in FIG. 5. Browser 403b may access the resource, in responding to the user request. A UI element handler component 433b may operate to present a UI element that represents the resource. A UI element handler component 433b corresponding to the resource UI element may include and/or otherwise interoperate with tag handler component 408b to present one more UI elements that represent of one or more tags with which the resource is tagged by sending presentation information to GUI subsystem 437b, as described above, to present the one or more tags along with the representation of the resource via an output device. Tag handler component 408b may operate to process input information from a user. Tag handler component 408b may operate to invoke resource access component 443b and/or resource access component 443d operating in execution environment 401d of service provider node 506. The invocation may be direct or indirect. One of the resource access components or both of the resource access components may locate one or more other resources tagged with matched tag and stored in a data store (not shown) of execution environment 401b and/or in a data store of execution environment 401d such as tagged store 447d. In an aspect, tag handler component 408b may interoperate with a content handler component 431b to send a message to network service 403d. The message may include a request for a resource and/or information that identifies the resource. Controller component 417d may route the request to a request handler component (not shown) to access the resource and/or identify the resource via resource access component 443d from a data store of hosting execution environment 401d. The request handler component operating in model subsystem 419d may invoke tag handler component 408d to generate presentation information to present a UI element to represent the tag and along with a UI element presented to represent the resource. Tag handler component 408d may send the presentation information via controller component 417d in a message to browser 403b. The presentation information in the message may be provided to a suitable content handler component 431b to interoperate with tag handler 408b and/or a resource UI element handler 433b to present the UI element that represents of the tag along with the resource UI element, as described above. Alternatively or additionally, the resource may be tagged in response to the request to present the resource by browser 403b and/or network service 403d.

In FIG. 4C, a request to present a resource may be detected by a UI element handler component 433c in application 403c operating in execution environment 401c. The application 403c may access the resource, in responding to the user request. A UI element handler component 433c in the application 403c may operate to interoperate with GUI subsystem 437c to present a resource in a resource UI element. A UI element handler component 433c corresponding to the resource UI element may include and/or otherwise interoperate with tag handler component 408c to present a representation of one or more matched tags with which the resource is tagged by sending presentation information to GUI subsystem 437c as describe above to present representation of the one or more matched tags along with a representation of the resource. Tag handler component 408c may operate to process input information from a user that corresponds to the representation of one of the matched tags. Tag handler component 408c may operate to locate another resource tagged with the matched tag via a resource access component 443c in tagging subsystem 407c. Alternatively or additionally, resource access component 408c may operate to perform a search based on the tagging criterion identified by the matched tag. When the tagging criterion is met for a resource located during the search, the resource may be tagged as described above via operation of one or more of tag director component 402c, criterion match component 404c, and tagging component 406c. Tagging subsystem 407c may provide services for multiple applications 403c, and in an aspect may allow multiple applications to share tags, tagging criterion, and/or resources.

The method illustrated in FIG. 2 may include additional aspects supported by various adaptations and/or analogs of the arrangement of components in FIG. 3.

In an aspect, creating a matched tag may include determining criterion information that identifies a tagging criterion. For example, determining criterion information for creating a matched tag may include receiving the criterion information from a user. With respect to FIG. 4A and FIG. 6A, a UI element 433a operating in execution environment 401a may send presentation information to present create matched tag UI element 606a, as described above. A user may specify and/or otherwise identify criterion information via a UI element, such as criterion field UI element 614a. Any suitable UI element suitable for prompting a user to provide input may be presented in various aspects.

In another aspect, one or more vocabularies and/or dictionaries may be identified based on a user input. Various aspects and analogs of execution environments 401 illustrated in FIGS. 4A-D may include and/or may access a component that manages a vocabulary of tags, such as a dictionary component 445. A user input processed by a UI element handler component 433 may identify a definition or a portion thereof for a tag in a dictionary processed by the dictionary component 445. The definition or portion thereof may valid according to a schema associated with the dictionary. A dictionary component 445 may access a schema maintained and processed external to the dictionary component 445 and/or may include instructions for maintaining and/processing the schema. A tag director component 402 and/or a tag handler 408 may identify criterion information in response to and/or otherwise based on identifying the dictionary. In an aspect, a definition or portion thereof may be located in a dictionary by a dictionary component 445. The dictionary may be identified in response to locating the and/or otherwise matching the definition and/or a portion thereof. In another aspect, tagging information, for creating a matched tag, may be determined by locating the tag in the dictionary. For example, by locating a definition that matches user input, the tag defined by the definition may be identified by a dictionary component 445 to provide to tag director component 402 to for creating a matched tag.

Alternatively or additionally, criterion information may be determined based on a definition or a portion thereof for the tag. A definition may include a text description, an identifier of a part of speech, an example use of the tag, a synonym for the tag, an antonym for the tag, a tense for the tag, an alternate spelling, a homonym, and terms derived from the tag such a plural form or a different tense. Criterion information may be determined and/or otherwise identified based on one or more parts of a definition such as these. With respect to FIGS. 4A-D, a definition may be located by a dictionary component 445 by performing a lookup based on a tag for creating a matched tag and/or based on user input identifying the definition. Some or all of the definition, as listed above, may be provided to a tag director component 402 as data included in criterion information that identifies a tagging criterion. For example, a definition of the term “read” may be past tense or present tense. Criterion information from a dictionary component 445 indicting past tense may be provided to a tag director component 402. The tag director 402 component may identify a tagging criterion that is met for a resource that has metadata, such as date of last access that indicates whether the resource has been utilized within a specified context. For example, the tagging criterion may be specified to match a resource that has not been read from a data storage medium since a particular date and/or time, processed by a particular application and/or device at any time, and/or accessed by particular user during a specified period; to name just a few examples.

As described above, one or more vocabularies and/or dictionaries may be identified based on a tag for creating a matched tag and/or may be identified based on a tagging criterion for creating the matched tag.

Criterion information and/or tagging information may be determined automatically in various aspects. Criterion information may be determined automatically based on at least one of the tag, a resource tagged with the tag, the user, and an input event associated with identifying the tag by the user. An aspect where criterion information is determined based on a tag is described above. The criterion information may be determined automatically in response to identifying a user identified tag.

Determining criterion information for creating a matched tag may include receiving a message sent via a network, from a remote device. The message may be sent and/or received in response to a user input detected by the remote device. A tag director component 402, in any of the arrangements in FIGS. 4A-D, may be adapted to invoke a dictionary component 445, automatically upon receiving tagging information by the tag director component 402. The criterion information may be determined based on the tag as described above.

Criterion information and, thus, a tagging criterion identified by the criterion information for creating a matched tag may be based on any data associated with a resource other than and/or in addition to a tag identified by the matched tag. For example, a tagging criterion may be based on one of more of the following that are associated with a resource that may be tagged: a user, the resource, a user input, a geospatial location, a time, a date, and a duration—to name a few examples.

With respect to a tagging criterion based on a user, a tagging criterion for creating a matched tag may be based on a creator of the matched tag, a role of a user with respect to a resource that can be tagged, an action performed by and/or at the request of a user that is associated with a resource that can be tagged, and/or a location of a user associated with a resource that can be tagged. A location upon which a tagging criterion may be based may be a permanent location associated with a user, a temporary location, a location identified in the context of an activity and/or other attribute related to a user, a personal attribute of a user, a device operated by and/or otherwise operating in response to and/or on behalf of a user, and/or a relation of a user or a group or organization.

For example, criterion information may be based a program component and/or application invoked by particular user in performing some or all of an operation based on a resource. In FIG. 4C, first application 403c1 may be implemented to perform operations for a user based on information in and/or associated with the user's account. Criterion information may identify a tagging criterion that is based on an account of a specified user. Second application 403c2 may be implemented to perform operations for a user that creates and/or changes resources on behalf of other users. Criterion information may be based on an access control role of a user of second application 403c2. User-based criterion information may be based on a device and/or hardware component being utilized by a particular user and/or otherwise associated with the user, personal information for a user such as gender and/or age, a task being performed by and/or on behalf of a specified user or group, and the like.

With respect to a tagging criterion based on a resource that can be tagged, a tagging criterion for creating a matched tag may be based on a MIME type of the resource, a size of the resource, a data and/or time associated with the resource, an attribute of processing the resource like a play time of an audio resource, a location of the resource and/or geospatial location of a physical entity that the resource represents and/or that is otherwise associated with, the content and/or a portion thereof of the resource, a use of the resource, a cost of the resource, a measure of utilization of the resource, and/or a rank like a rank or measure of popularity or quality of the resource. Any of execution environments 401 in FIGS. 4A-D and their adaptations and/or analogs may include a tag director component 402 to identify criterion information, and thus a tagging criterion, based on any one or more of the above. For example, as described above with respect to FIG. 4C, tag director component 402c may identify criterion information based an application and/or operation that includes processing a resource that may be tagged with a tag identified by a matched tag that identifies the tagging criterion identified by the criterion information.

In another example, criterion information for creating a matched tag may be based on a count of accesses to a resource. The count may be specific to a user, a group, a span of time, and/or may have other contextual constraints. For example, tag director component 402 may identify criterion information that identifies a tagging criterion that is only met for a resource if it has been accessed at least once within any other contextual constraints specified by the tagging criterion. Alternatively or additionally, a tag director component 402 may identify criterion information based on a cost of power associated with processing a resource. A tagging criterion identified by such criterion information may match a resource if its cost of processing according a particular metric meets a threshold condition. Thus resources that meet the threshold condition may be tagged with the tag identified by the matched tag that identifies the tagging criterion based on the threshold condition. The two previous examples illustrate that criterion information for creating a matched may be based on a measure of utilization of a resource that is and/or may be tagged with a tag.

One or more measures of temperature or humidity may be communicated to a tag director component 402, operating in an execution environment 401, as criterion information and/or as data included in criterion information. The tag director component 402 may identify a tagging criterion based on the criterion information. For example, a tagging criterion may be met for a resource having an associated measure of heat within a range and/or otherwise meeting a threshold condition specified by the tagging criterion. The tagging director component 402 may receive and/or otherwise identify tagging information identifying a tag for creating a matched tag identifying the tag and the tagging criterion. More specifically, a tagging director component 402 may create a number of tags based on various measures of temperature and various respective tags, such as “Normal”, “Alert”, and “Warning”. Such tags may be used by an application or system that monitors one or more devices which may be located at various locations. Temperature information from the one or more locations may be communicated to a node including and/or otherwise included in an execution environment 401. A criterion match component 404 may be invoked in response to receiving temperature information. Tagging criteria identified by the respective matched tags may also be based on location and/or other information for identifying a particular device or group of devices. In response to receiving temperature information for a location, the criterion match component 404 may locate any resources representing the electronic devices and/or locations to determine whether tagging criterion identified by each of one or more of the matched tags is met or is no longer met. In response, to determining that that a tagging criterion is met or no longer met for a resource, a tagging component 406 may be invoked to untag and/or to tag the resource. Note that user viewing a representation of a monitored device and/or a location may direct input to a tag for the resource to locate other resources with the matched tag. A user may see via a display that a resource tagged with the tag, “Normal” is untagged with respect to the “Normal” tag and may see an “Alert” tag represented, in response to the resource being tagged with the “Alert” tag. The user may locate one or more other resources tagged with the “Alert” tag by directing an input to the “Alert” UI element and/or an associated UI element. Thus, the present disclosure enables dynamic tagging and untagging in response to changing information. Associations between and/or among resources tagged with a same tag are updated dynamically.

In still another aspect, criterion information and thus a tagging criterion for creating a matched tag may be based on a measure of attention and/or a measure of interaction for the user. Thus various metrics and measures of user interaction and/or the lack of it may be included in a tagging criterion to identify various objects and devices based on user interaction and/or attention to the respective various devices. Resources that represent the various resources and/or user may be tagged with tags bound to tagging criterion by various matched tags. Such tagging may be relatively persistent and/or dynamic based on the metrics, measurements, and specification of matching criteria. Given a resource tagged with a particular matched tag, other resources may be easily located, Thus inattentive students, machine operators, customers may be identified over long periods of time with persistent tags that may be associated with matching criteria based on long-term metrics such as an average over a period and/or over relative shorter periods based on metrics that may provide changing measurements over time. Similar status and/or time base matching criteria may be specified to tag resources of various types according a rank such as popularity or satisfaction, lab data for human health, presence data such as presence status, and the like. Another example of a type of data that a category of matching criteria may be based on that may be persistent and/or volatile depending on the particular tagging criterion, is matching criteria based on geospatial location. Some resources don't move others move. It should be apparent given the description herein to those skilled in the art of specifying matching criteria that matching and, thus, a tagging criterion may be based on a metric and/.or measure for one or more of a time, a date, and a duration.

Determining criterion information for creating a matched tag may be based on a communication that identifies at least one of a resource, the tag, and metadata for the resource, an initiator of the communication, and an acceptor of the communication. For example, attachments exchanged in emails, MMS, and/or other user communications technologies and systems may be identified and tagged according to the teaching herein.

In an aspect, creating a matched tag may include identifying a user provided tag automatically, in response to determining the criterion information. In an instance of the aspect, determining criterion information for creating a matched tag may include identifying a vocabulary and/or a dictionary. A tag for creating a matched tag may be identified by locating a definition in a dictionary based criterion information.

As described above, one or more vocabularies and/or dictionaries may be identified based on a user input. Various aspects and analogs of execution environments 401 illustrated in FIGS. 4A-4D may include and/or may access a component that manages a vocabulary of tags, such as dictionary component 445. A user input processed by a UI element handler component 433 may identify a definition or a portion thereof for a tag in a dictionary processed by the dictionary component 445. The definition or portion thereof may be, may be included in, and/or may otherwise identify criterion information. A tag director component 402 and/or a tag handler 408 may identify tagging information in response to and/or otherwise based on identifying the dictionary. In an aspect, a definition or portion thereof, identified by a user, may be located in a dictionary by a dictionary component 445. A term defined by the definition may identify some or all of an instance of tagging information and/or a portion of the definition may identify tagging information or a portion thereof, such as a synonym identified in the located definition. By locating a definition that matches user input in a dictionary, the tag defined by the definition may be identified by a dictionary component 445 to provide to tag director component 402 to create a matched tag.

A vocabulary and/or a dictionary may be predefined, may be user specified, or may include a pre-defined portion and a user specified portion. Thus, a tag for creating a matched tag may be added to one or more vocabularies and/or dictionaries by a user in some aspects. Predefined tags may be provided by a software developer, an administrator or an application, service, and/or system, and/or by an owner or employee of an owner of an application, service, and/or system that includes and/or otherwise accesses a vocabulary and/or dictionary.

In another aspect, creating a matched tag may include receiving criterion information identifying a tagging criterion for the matched tag while no resource is tagged with the tag. That is the matched tag may be created that identifies a pre-defined tag that is unused and/or a user defined tag that that is either unused or has not been specified previously.

Creating a matched tag may include receiving, from a user, tagging information that identifies a tag. Receiving the tagging information may include receiving a message sent via a network, from a remote device, in response to a user input detected by the remote device. Tagging information may be received while no resource for tagging is presented to the user via an output device. This is described above with respect to FIG. 6A and FIGS. 4A-D.

Also as described above, in another aspect, tagging information may be received while a resource that can be tagged is presented to a user. The tagging information may be received and/or otherwise identified in response to a user input detected while the resource is presented. A representation of a resource may be presented to a user. The resource may be tagged with the matched tag or the process of tagging the resource with the matched tag may be occurring. The tag may be identified based on a user input that corresponds to a UI element that includes and/or is otherwise associated with the representation of the resource.

Exemplary resources that may be tagged include documents and other text data, image data including pictures and video, audio data, form data, streaming data, user accounts, representations of user groups, legal entities, executable entities, hardware components, a network and/or Web based services, and a computer resources such as disks, threads, memory, and the like.

A determination that a tagging criterion is met for a resource may be performed in response to an access to the resource by a hardware and optionally by a software component. An access to a resource may be in response to an user input detected via an input device. The access may be detected by detecting the user input. The user input may target and/or otherwise correspond to a UI element presented for accessing and/or for presenting a representation of a resource that may be tagged with a matched tag for which the tagging criterion is determined to be met.

Determining that a tagging criterion is met may include performing a search operation and receiving a result identifying a set of matching resources. The search may be based on tagging criterion. A criterion match component may operate to perform a search operation, provide for performing a search operation, and/or receive results of a search operative via interaction, direct and/or indirect, with a search engine. Alternatively, a separate determination may be made for each resource identified in the result to identify any resources for which the tagging criterion is met.

In an aspect, a resource and/or an attribute of the resource may change. The change may be detected by an application and/or by a resource access component. Determining whether the tagging criterion is met for the resource may be performed in response to detecting the change.

Thus determining one or more resources for which a tagging criterion is met may be performed at a given time for resources that may be tagged with the matched tag. Alternatively or additionally, such a determination may be made when an access to a resource is detected. Alternatively or additionally, such a determination may be made when change to a resource and/or an attribute associated with the resource is detected. Still further, such a determination may be made when a resource is created and/or otherwise initially identified. In yet another aspect, such a determination may be made in response to a user input indicating that the determination is to be performed.

A resource for which a tagging criterion, identified by a matched tag, is met, may be tagged by creating a tagged association that identifies matched tag and the resource. A tagged association may be stored, by a tag director component, in a storage location, wherein the storage location may be included in at least one of a volatile data storage medium and a non-volatile data storage medium, such as a tagging store illustrated in FIG. 4A, FIG. 4C, and FIG. 4D. A tagged association may be a matched tagged association that identifies the tagging criterion. A matched tagged association, thus, identifies a matched tag and a resource.

A resource may be tagged with a tag identified by a matched tag automatically in response to the determining that the tagging criterion, identified by the matched tag, is met for the resource. Tagging a resource may be performed automatically in response to creating a matched tag.

A resource may be tagged automatically in response to detecting the resource. A resource may be detected directly and/or indirectly. In one aspect, a resource is detected indirectly in response to receiving and/or determining an identifier for the resource. Alternatively or additionally, a resource may be detected by detecting, directly and/or indirectly, an access to the resource. The resource may be accessed by a hardware component for processing based on an instruction executed by a processor. A resource may be detected by detecting an access for presenting a representation of the resource to a user via an output device. Detecting the access may include detecting an input corresponding to a UI element that includes a representation of at least one of the matched tag and the resource. A resource may be detected in a search result set. A search operation that produces a result set may be based on a tag in a matched tag and/or may be based on a tagging criterion in the matched tag.

A resource may be tagged with a matched tag by creating a tagged association that identifies the matched tag and the resource. A tagged association may identify a tag by including and/or otherwise identifying tagging information. A tagging criterion may be identified by including and/or otherwise identifying criterion information. Such an association may be stored in a memory location which may be contiguous or not with respect to a physical storage medium and/or with respect to a virtual memory or logical storage system, such as file system or database. A memory location including a tagged association may be volatile, persistent, may be split between volatile and persistent memory, and/or may be replicated in one or more volatile and/or persistent memory locations.

In an aspect, tag UI element may represent a matched tag for a resource tagged with the matched tag while a representation of the resource is represented by and/or in a resource UI element along with the presented matched tag. Input information may be received via a tag handler component, in response to a user input targeting the representation that identifies the matched tag. Another resource, for which the tagging criterion in the matched tag that identifies the tag, may be located and/or otherwise identified by a tagging component and/or a resource access component, in response to receiving the input information. Presentation information may be sent by a tag handler component to present a UI element to represent the other resource to the user via an output device. The presentation information may be sent in response to locating the other resource. The other resource may be located based on the tag and/or the tagging criterion.

In another aspect a tag identified by a first matched tag that identifies a first tagging criterion may also be identified by a second matched tag that identifies a second tagging criterion. A tagging director component may locate such tagging associations. A resource for which the first tagging criterion is met and for which the second tagging criterion is met may be tagged a first time based on the first matched tag and may be tagged a second time based on the second matched tag by a tagging component.

For a resource tagged with a tag identified by more than one matched tag that each identifies a tagging criterion met for the resource, a first UI element that represents the tag may be presented, by a tag handler component, along with a UI element that represents the resource based on a first matched tag. Alternatively or additionally, a second UI element that represents of the tag may be presented along with the resource UI element based on the second matched tag. The first UI element representing the tag and the second UI element representing of the tag may have a user detectable difference, where the difference is based on a difference between the first tagging criterion and the second tagging criterion, or more broadly, based on a difference between the first matched tag and the second matched tag. In FIG. 6B, the resource UI element 622b is tagged with “Landscape” a first time, illustrated by tag UI element 624b and tagged with “Landscape” a second time, illustrated by tag UI element 628b. The tag represented by tag UI element 624b is identified by a matched tag that identifies a tagging criterion based on criterion information identified in form field UI element 614a in FIG. 6A which is based on a specific user account identifier. Tag UI element 624b is presented with a “<” icon or character to indicate that the scope of the tag, as specified by its tagging criterion, is restricted to a single account. The “Landscape” tag represented by tag UI element 628b is identified by a matched tag that identifies a tagging criterion that does not restrict resources that can be tagged to a single account. Tag UI element 628b is presented with a “>” icon or character which may be defined to indicate the scope of the matched tag crosses spans multiple user accounts. Any additional symbol, character, and/or visual attribute may be defined to distinguish, to a user, matched tags that identify the same tag. A user input corresponding to a first UI element representing a tag having a first tagging criterion may result in a first set of resources that are associated via the tag and the first tagging criterion. A user input corresponding to a second UI element representing the tag having a second tagging criterion may result in a second set of resources that are associated via the tag and the second tagging criterion. The first set and the second set may differ.

In yet another aspect, a representation of some or all of a tagging criterion may be presented, by a tag handler component, along with and/or otherwise in response to a user input directed to a representation of tag, where the tag and the tagging criterion are identified by a matched tag. For example, a right-click of mouse input device corresponding to a pointer UI element over tag UI element 624b in FIG. 6B may result in input information based on the input being provided to a UI element handler 433 and/or a tag handler component 408 that corresponds to tag UI element 624B. In response to receiving the input information the UI element 433 and/or the tag handler component 408may invoke another UI element 433 and/or another tag handler component 408 to send presentation information to present a UI element that represents of the tagging criterion identified by the matched tag that identifies that tag represented by tag UI element 624b. A representation of the tagging criterion determined for an identified tag may be presented along with the representation of the tag. It may be presented in a same UI element or in a separate UI element such as a dialog box or flyover text in response to a user input.

As described above with respect to FIGS. 6B-C, an aspect of the method in FIG. 2, includes receiving input information by a tag handler component, in response to a user input targeting a UI element that represents of a matched tag presented along with a tagged resource. A second resource, tagged with the matched tag, may be located and/or otherwise identified by a tagging component and/or a resource access component, in response to receiving the input information. A representation of the identified second resource may be presented to the user via an output device.

Performing the method illustrated in FIG. 2 and/or any of its extension and/or in any of its aspects may include one or more of calling a function or method of an object, sending a message via a network; sending a message via an inter-process communication mechanism such as a pipe, a semaphore, a shared data area, and/or a queue; and/or receiving a request such as poll and responding to invoke, and sending an asynchronous message.

Output devices suitable for presenting a representation of a resource and/or a tag include a visual output device, an audio output device, and a tactile output device. One output device may present a resource and another output device may present a tag with which the resource is tagged.

As described the method may be performed by a non-networked device, a networked device, and/or may be performed may more than one device, and/or by more than one executable environment. As such, one or more of determining criterion information, determining that tagging criterion is met, tagging, and sending presentation information may include sending and/or receiving a message via a network. Further, a message, included in performing any of the subject matter described herein and/or any of its extensions in any of its aspects, may an asynchronous message without a corresponding request.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein may be embodied in executable instructions stored in a non-transitory computer readable storage medium for use by or in connection with an instruction execution machine, system, apparatus, or device, such as a computer-based or processor-containing machine, system, apparatus, or device. As used here, a “non-transitory computer readable storage medium” may include one or more of any suitable media for storing the executable instructions of a computer program in one or more forms including an electronic, magnetic, optical, and electromagnetic form, such that the instruction execution machine, system, apparatus, or device may read (or fetch) the instructions from the non-transitory computer readable storage medium and execute the instructions for carrying out the described methods. A non-transitory computer readable storage medium is non-transitory. A non-exhaustive list of conventional exemplary non-transitory computer readable storage media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), and a Blu-ray·8 disc; and the like

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A system for tagging a resource, the system comprising:
a tag director component for creating a matched tag by associating a user identified tag with a tagging criterion that is based on data other than the tag;
a criterion match component for automatically determining that the tagging criterion is met for each resource in a plurality of resources;
a tagging component for automatically tagging each resource in the plurality with the tag, in response to the determining; and
a tag handler component for automatically sending presentation information to present, via an output device, a tag user interface element, that represents the tag, as a target for a user input to initiate an operation that identifies a resource in the plurality; and
a processor, wherein at least one of the tag director component, the criterion match component, the tagging component, and the tag handler component includes an instruction that is executed by the processor during operation of the system;
wherein determining that the tagging criterion is met for a first resource in the plurality includes:
detecting a change to an attribute associated with the first resource; and
automatically determining the tagging criterion is met in response to detecting the change.

2. The system of claim 1 wherein the creating includes:
receiving criterion information, from the user, that identifies the tagging criterion; and
identifying the tag automatically, in response to receiving the criterion information.

3. The system of claim 1 wherein the creating includes:
receiving tagging information identifying the tag; and
determining the tagging criterion, in response to identifying the tag.

4. The system of claim 1 further includes adding the tag to the at least one of a vocabulary of tags and a dictionary of tags.

5. The system of claim 1 wherein the tag is identified based on at least one of the tagging criterion and a resource tagged with the tag.

6. The system of claim 1 wherein the creating includes receiving criterion information identifying the tagging criterion while no resource is tagged with the tag.

7. The system of claim 1 wherein the creating includes receiving, from the user, tagging information that identifies the tag.

8. The system of claim 7 wherein the tagging information is received while no resource for tagging is presented to the user via an output device.

9. The system of claim 7 wherein receiving the tagging information includes:
presenting a resource to the user, wherein the resource is for tagging; and
receiving the tagging information in response to a user input detected by an input device while the resource is presented.

10. The system of claim 1 wherein at least one resource in the plurality includes at least one of text data, image data, audio data, form data, streaming data, a user, a group, a legal entity, an executable program component, a hardware component, a service, or a process.

11. The system of claim 1 wherein determining that the tagging criterion is met for a first resource in the plurality includes receiving, from a search operation based on the tagging criterion, a result identifying the first resource.

12. The system of claim 1 wherein the tagging is performed automatically in response to creating the matched tag.

13. The system of claim 1 wherein the tagging is performed automatically, in response to detecting the first resource, subsequent to creating the matched tag.

14. The system of claim 13 wherein the first resource is detected in response to creating an identifier for the first resource.

15. The system of claim 13 wherein the tagging includes receiving a result of a search operation, based on a tag, that identifies the first resource.

16. The system of claim 13 wherein the tagging includes receiving, from a search operation, based on the tagging criterion, a result identifying the first resource.

17. The system of claim 1 wherein the tag user interface element represents the tag for a first resource in the plurality represented by a resource user interface element presented along with the tag user interface element and the system further includes:
receiving input information, in response to the user input targeting the tag user interface element;
locating a second resource in the plurality, in response to receiving the input information; and
presenting a representation of the second resource to the user via an output device.

18. A non-transitory computer readable medium embodying a computer program, executable by a machine, for tagging a resource, the computer program comprising executable instructions for:
creating a matched tag by associating a user identified tag with a tagging criterion that is based on data other than the tag;
automatically determining that the tagging criterion is met for each resource in a plurality of resources;
automatically tagging each resource in the plurality with the tag, in response to the determining; and
automatically sending presentation information to present, via an output device, a tag user interface element, that represents the tag, as a target for a user input to initiate an operation that identifies a resource in the plurality;
wherein determining that the tagging criterion is met for a first resource in the plurality includes:
detecting a change to an attribute associated with the first resource; and
automatically determining the tagging criterion is met in response to detecting the change.
